(19) United States
(12) Patent Application Publication
(10) Pub. No.: US 2026/0043412 A1
(43) Pub. Date: Feb. 12, 2026

(54) METHOD FOR MANUFACTURING CENTRIFUGAL FAN AND CENTRIFUGAL FAN

(71) Applicant: DENSO CORPORATION, Kariya-city (JP)

(72) Inventors: Ryosuke INOUE, Kariya-city (JP); Fumiya ISHII, Kariya-city (JP); Jun YAMAOKA, Kariya-city (JP); Takumi ITO, Kariya-city (JP)

(21) Appl. No.: 19/363,530

(22) Filed: Oct. 20, 2025

Related U.S. Application Data
(63) Continuation of application No. PCT/JP2024/015328, filed on Apr. 17, 2024.

(30) Foreign Application Priority Data
Apr. 27, 2023 (JP) 2023-073558

(51) Int. Cl. F04D 29/28; B29C 45/14; B29L 31/08; F04D 17/08; F04D 29/62

(52) U.S. Cl. CPC F04D 29/281; B29C 45/14336; F04D 17/08; F04D 29/624; B29L 2031/08

(57) ABSTRACT

A manufacturing method of a centrifugal fan includes assembling first to fourth dies. The first die molds a main plate. The second die molds: a main plate inner region of the main plate; a convex portion of each blade; a negative pressure surface of a leading edge portion of each blade; and each first region of the main plate. Each third die molds: a positive pressure surface of trailing and leading edge portions of one of adjacent two blades; the negative pressure surface of the trailing edge portion of the other one of the adjacent two blades; a second region of the main plate; and an adjacent portion of the ring. The fourth die molds the ring. The method includes: injecting a material into a molding region formed by the first to fourth dies; molding an integrated article; and separating the first to fourth dies from the integrated article.

### CROSS REFERENCE TO RELATED APPLICATIONS

This application is a continuation application of International Patent Application No. PCT/JP2024/015328 filed on Apr. 17, 2024, which designated the U.S. and claims the benefit of priority from Japanese Patent Application No. 2023-073558 filed on Apr. 27, 2023. The entire disclosures of all of the above applications are incorporated herein by reference.

### TECHNICAL FIELD

The present disclosure relates to a method for manufacturing a centrifugal fan and the centrifugal fan.

### BACKGROUND

A previously proposed centrifugal fan includes: a plurality of blades arranged in a circumferential direction about an axis; a shroud ring; and a main plate. The shroud ring is joined to the blades on one side in an axial direction. The main plate is joined to the blades on the other side in the axial direction. An air flow passage is formed between each adjacent two of the blades. Accordingly, when the centrifugal fan is rotated toward a forward side in a rotational direction about the axis, air, which is drawn from the one side in the axial direction into the air flow passages, is discharged from the air flow passages toward an outer side in a radial direction.

### SUMMARY

This section provides a general summary of the disclosure, and is not a comprehensive disclosure of its full scope or all of its features.

According to the present disclosure, there is provided a method for manufacturing a centrifugal fan. The centrifugal fan may include a plurality of blades, a ring and a main plate. The plurality of blades may be arranged at intervals in a circumferential direction about an axis. The ring may be formed in a ring shape and centered on the axis. A direction, in which the axis extends, may be defined as an axial direction, and the ring may be joined to the plurality of blades on one side in the axial direction. The main plate may have a thickness in the axial direction. The main plate may be joined to the plurality of blades on another side in the axial direction. When the plurality of blades, the ring and the main plate are rotated together toward a forward side in a rotational direction about the axis, air, which is drawn from the one side in the axial direction, is blown toward an outer side in a radial direction about the axis. Each of the plurality of blades may include: a leading edge portion that is disposed on an inner side of the ring in the radial direction about the axis; and a trailing edge portion that is disposed on the outer side of the leading edge portion in the radial direction. Each of the plurality of blades may further include: a positive pressure surface that faces the forward side in the rotational direction; and a negative pressure surface that faces a backward side in the rotational direction. In a cross-section of the leading edge portion of each of the plurality of blades taken along a virtual plane perpendicular to the radial direction, the negative pressure surface may be formed by at least one line which extends toward the forward side in the rotational direction as the at least one line extends toward the one side in the axial direction. In the cross-section of the leading edge portion of each of the plurality of blades, the positive pressure surface may be formed by at least one of: a line that extends toward the forward side in the rotational direction as the line extends toward the one side in the axial direction; and a line that extends in parallel with the axis. An end part of the positive pressure surface of the leading edge portion, which is positioned furthest toward the one side in the axial direction, may be defined as a positive pressure surface end part. An end part of the negative pressure surface of the leading edge portion, which is positioned furthest toward the one side in the axial direction, may be defined as a negative pressure surface end part. The leading edge portion includes a convex portion that bulges from a virtual line that connects between the positive pressure surface end part and the negative pressure surface end part. A virtual line, which passes through the positive pressure surface end part and extends in the axial direction in the cross-section of the leading edge portion, may be defined as a first reference line, and a virtual line, which passes through the negative pressure surface end part and extends in the rotational direction in the cross-section of the leading edge portion, may be defined as a second reference line, and the convex portion is disposed on the backward side of the first reference line in the rotational direction and on the another side of the second reference line in the axial direction. The method may include assembling a first die, a second die, a plurality of third dies and a fourth die together. The first die may be configured to mold a side of the main plate which faces the another side in the axial direction. The second die may be configured to mold: a side of a main plate inner region of the main plate, which faces the one side in the axial direction, wherein the main plate inner region is disposed on the inner side of the plurality of blades in the radial direction; the convex portion of each of the plurality of blades; the negative pressure surface of the leading edge portion of each of the plurality of blades; and a side of each of a plurality of first regions of the main plate which faces the one side in the axial direction, wherein each of the plurality of first regions is disposed on the outer side of the main plate inner region in the radial direction and is joined to the negative pressure surface of the leading edge portion of an adjacent one of the plurality of blades that is adjacent to the first region. Each of the plurality of third dies may be configured to mold: the positive pressure surface of each of the trailing edge portion and the leading edge portion of one of adjacent two of the plurality of blades that are disposed adjacent to the third die; the negative pressure surface of the trailing edge portion of another one of the adjacent two of the plurality of blades; a side of a second region of the main plate which is disposed adjacent to the third die and faces the one side in the axial direction, wherein the second region is disposed between the adjacent two of the plurality of blades and is disposed on the outer side of a corresponding one of the plurality of first regions in the radial direction, and the corresponding one of the plurality of first regions is disposed between the adjacent two of the plurality of blades; and a side of an adjacent portion of the ring which is adjacent to the third die and faces the another side in the axial direction; and the fourth die is configured to mold a side of the ring which faces the one side in the axial direction. The method may include: injecting a material, which has flowability, into a molding region that is formed by the first die, the second die, the plurality of third dies and the fourth die; molding an integrated article, which includes the plurality of blades, the ring and the main plate integrated together, in the molding region, by solidifying the material injected into the molding region; and separating the first die, the second die, the plurality of third dies and the fourth die from the integrated article.

### BRIEF DESCRIPTION OF DRAWINGS

The drawings described herein are for illustrative purposes only of selected embodiments and not all possible implementations, and are not intended to limit the scope of the present disclosure.

FIG. 1 is a front view of a blower device according to a first embodiment, for assisting in the explanation of a blower casing, a plurality of blades, and a main plate.

FIG. 2 is a perspective view of the blower device of the first embodiment of FIG. 1, for assisting in the explanation of the blades and the blower casing.

FIG. 3 is a cross-sectional view taken along line III-III of the blower device in FIG. 1, for assisting in the explanation of the blades, a shroud ring, and the main plate.

FIG. 4 is a cross-sectional view of a centrifugal fan of FIG. 1, taken along a virtual plane including an axis, for assisting in the explanation of a trailing edge portion and a leading edge portion of each of the blades, and an outer region and an inner region of the shroud ring.

FIG. 5 is a cross-sectional view taken along line V-V in FIG. 4, which is a cross-sectional view of the leading edge portion of the blade taken along a virtual plane that passes through an arbitrary point of the leading edge portion and is perpendicular to the radial direction, for assisting in the explanation of an inclined shape of the leading edge portion of the blade, and an intermediate inner region and an intermediate outer region of the main plate.

FIG. 6 is a partial enlarged view of a portion in FIG. 5, for assisting in the explanation of an arcuate convex portion of the leading edge portion of the blade.

FIG. 7 is a transparent view showing a portion of the centrifugal fan of FIG. 1 in a state where the shroud ring is viewed through, for assisting in the explanation of a main plate outer region, a main plate inner region, a main plate intermediate region, an intermediate inner region and an intermediate outer region of the main plate.

FIG. 8 is a flowchart for assisting in the explanation of details of a method for manufacturing the centrifugal fan according to the first embodiment of FIG. 1.

FIG. 9 is a view showing a state before injection of a resin material into a molding region in a state where a lower die, a plurality of lower slide dies, a plurality of upper slide dies, an axial core die and a ring die are assembled together in a die placement step of the method for manufacturing the centrifugal fan of FIG. 8 according to the first embodiment.

FIG. 10 is a view showing a state where the resin material is injected into the molding region in the state where the lower die, the lower slide dies, the upper slide dies, the axial core die and the ring die are assembled together in the method for manufacturing the centrifugal fan of FIG. 8 according to the first embodiment.

FIG. 11 is a cross-sectional view for assisting in the explanation of molding the leading edge portion of the blade of the centrifugal fan by the lower slide die, the upper slide die and the axial core die shown in FIG. 8 according to the first embodiment, corresponding to the cross-sectional view of FIG. 5.

FIG. 12 is a cross-sectional view for assisting in the explanation of a separation step for separating the lower slide dies, the upper slide dies and the axial core die from an integrated article in the method for manufacturing the centrifugal fan of FIG. 8 according to the first embodiment.

FIG. 13 is a cross-sectional view taken along line XIII-XIII in FIG. 10 according to the first embodiment, for assisting in the explanation of the separation step of the method for manufacturing the centrifugal fan of FIG. 8 according to the first embodiment, showing a state where the lower slide dies and the upper slide dies are separated from the integrated article.

FIG. 14 is a view showing a state where an upper die interferes with an arcuate convex portion of a leading edge portion of a blade of a centrifugal fan in a method for manufacturing a centrifugal fan in a comparative example.

FIG. 15 is a view showing a state where the axial core die forms the arcuate convex portion of the leading edge portion of the blade of the centrifugal fan in the method for manufacturing the centrifugal fan according to the first embodiment.

FIG. 16 is a view showing a state where an airflow is separated from a negative pressure surface of the leading edge portion of the blade in the comparative example.

FIG. 17 is a view showing a state where separation of an airflow from the negative pressure surface in the centrifugal fan of the first embodiment is suppressed, thereby allowing the airflow to flow along the negative pressure surface.

FIG. 18 is a cross-sectional view, taken along a virtual plane perpendicular to the radial direction and passing through the leading edge portion of the blade in the centrifugal fan according to a second embodiment, for assisting in the explanation of a shape of the positive pressure surface of the leading edge portion, the cross-sectional view corresponding to the cross-sectional view of FIG. 5 in the first embodiment.

FIG. 19 is a cross-sectional view, taken along the virtual plane perpendicular to the radial direction and passing through the leading edge portion of the blade, in the centrifugal fan according to a third embodiment, for assisting in the explanation of the shape of the positive pressure surface of the leading edge portion, the cross-sectional view corresponding to the cross-sectional view of FIG. 5 in the first embodiment.

FIG. 20 is a cross-sectional view, taken along the virtual plane perpendicular to the radial direction and passing through the leading edge portion of the blade, in the centrifugal fan according to a fourth embodiment, for assisting in the explanation of a shape of the positive pressure surface of the leading edge portion, the cross-sectional view corresponding to the cross-sectional view of FIG. 5 in the first embodiment.

FIG. 21 is a cross-sectional view, taken along the virtual plane perpendicular to the radial direction and passing through the leading edge portion of the blade, in the centrifugal fan according to a fifth embodiment, for assisting in the explanation of a shape of the positive pressure surface of the leading edge portion, the cross-sectional view corresponding to the cross-sectional view of FIG. 5 in the first embodiment.

FIG. 22 is a partial enlarged view showing the blade and a portion of the shroud ring in the centrifugal fan according to a sixth embodiment.

FIG. 23 is a cross-sectional view of the centrifugal fan in FIG. 22 according to the sixth embodiment, taken along a virtual plane including the axis, for assisting in the explanation of a leading-edge inclined portion and a leading-edge non-inclined portion of the leading edge portion of each of the blades.

FIG. 24 is a cross-sectional view taken along line XXIV-XXIV in FIG. 23 according to the sixth embodiment, for assisting in the explanation of an inclination angle of the negative pressure surface of the leading edge portion of each of the blades.

FIG. 25 is a cross-sectional view taken along line XXV-XXV in FIG. 23 according to the sixth embodiment, for assisting in the explanation of the inclination angle of the negative pressure surface of the leading edge portion of each of the blades.

FIG. 26 is a cross-sectional view taken along line XXVI-XXVI in FIG. 23 according to the sixth embodiment, for assisting in the explanation of the inclination angle of the negative pressure surface of the leading edge portion of each of the blades.

FIG. 27 is a cross-sectional view, taken along the virtual plane perpendicular to the radial direction and passing through the leading edge portion of the blade, in the centrifugal fan according to a seventh embodiment, for assisting in the explanation of shapes of the negative pressure surface and the positive pressure surface of the leading edge portion of each of the blades, the cross-sectional view corresponding to the cross-sectional view of FIG. 5 in the first embodiment.

FIG. 28 is a cross-sectional view, taken along the virtual plane perpendicular to the radial direction and passing through the leading edge portion of the blade, in the centrifugal fan according to an eighth embodiment, for assisting in the explanation of shapes of the negative pressure surface and the positive pressure surface of the leading edge portion of each of the blades, and the cross-sectional view corresponding to the cross-sectional view of FIG. 5 in the first embodiment.

FIG. 29 is a cross-sectional view, taken along the virtual plane perpendicular to the radial direction and passing through the leading edge portion of the blade, in the centrifugal fan according to a ninth embodiment, for assisting in the explanation of shapes of the negative pressure surface and the positive pressure surface of the leading edge portion of each of the blades, the cross-sectional view corresponding to the cross-sectional view of FIG. 5 in the first embodiment.

### DETAILED DESCRIPTION

A previously proposed centrifugal fan includes: a plurality of blades arranged in a circumferential direction about an axis; a shroud ring; and a main plate. The shroud ring is joined to the blades on one side in an axial direction. The main plate is joined to the blades on the other side in the axial direction. An air flow passage is formed between each adjacent two of the blades. Accordingly, when the centrifugal fan is rotated toward a forward side in a rotational direction about the axis, air, which is drawn from the one side in the axial direction into the air flow passages, is discharged from the air flow passages toward an outer side in a radial direction.

The shroud ring is formed in a ring shape centered on the axis and is connected to the blades on the one side in the axial direction. Each of the blades includes a leading edge portion that is disposed on an inner side of the shroud ring in the radial direction.

A one-side section of the leading edge portion, which faces the one side in the axial direction, is inclined such that the one-side section is disposed on the forward side in the rotational direction relative to an other-side section of the leading edge portion, which is disposed on the other side of the one-side section in the axial direction.

A negative pressure surface of the leading edge portion is inclined such that the negative pressure surface extends toward the forward side in the rotational direction as the negative pressure surface extends toward the one side in the axial direction. This makes it possible to suppress separation of an airflow from the negative pressure surface of the leading edge portion of each of the blades in the vicinity of the shroud ring.

The inventors of the present application have studied a manufacturing method for integrally molding the plurality of blades and the shroud ring in the above-described centrifugal fan by injection molding using dies.

For example, in order to suppress the separation of the airflow from a distal end side of the leading edge portion, which faces the one side in the axial direction, a convex portion, which is formed in a convex shape, is provided at the distal end side.

In this case, when the leading edge portion of the blade is molded with an upper die and a lower die which is placed on the other side of the upper die in the axial direction, it is considered that the following disadvantage may be encountered.

Here, it is assumed that a part of the leading edge portion of the blade, which is positioned furthest toward the forward side in the rotational direction, is defined as a foremost part. A part of the convex portion, which faces the forward side in the rotational direction and is positioned furthest toward the other side in the axial direction in the convex portion, is defined as a lowermost part. Furthermore, a region of the convex portion, which faces the forward side in the rotational direction and is located on the one side of the lowermost part in the axial direction, is defined as a positive pressure upper region.

Here, the negative pressure surface of the leading edge portion and the convex portion are molded by the upper die, and the positive pressure surface of the leading edge portion is molded by the lower die. In particular, the positive pressure upper region of the convex portion is molded by the upper die.

In this case, in a state where the foremost part of the leading edge portion is disposed on the one side of the lowermost part in the axial direction, and a resin material injected into a molding region between the upper die and the lower die is solidified, the upper die is fitted to the positive pressure upper region of the leading edge portion.

Therefore, when the upper die is moved toward the one side in the axial direction relative to the leading edge portion in order to separate the upper die from the leading edge portion, the upper die interferes with the positive pressure upper region of the leading edge portion.

As a result, the upper die cannot be separated from the leading edge portion. Therefore, the centrifugal fan cannot be integrally molded.

According to one aspect of the present disclosure, there is provided a method for manufacturing a centrifugal fan, the centrifugal fan including:
a plurality of blades that are arranged at intervals in a circumferential direction about an axis;
a ring that is formed in a ring shape and is centered on the axis, wherein a direction, in which the axis extends, is defined as an axial direction, and the ring is joined to the plurality of blades on one side in the axial direction; and
a main plate that has a thickness in the axial direction, wherein the main plate is joined to the plurality of blades on another side in the axial direction, wherein:
when the plurality of blades, the ring and the main plate are rotated together toward a forward side in a rotational direction about the axis, air, which is drawn from the one side in the axial direction, is blown toward an outer side in a radial direction about the axis;
each of the plurality of blades includes:
   a leading edge portion that is disposed on an inner side of the ring in the radial direction about the axis; and
   a trailing edge portion that is disposed on the outer side of the leading edge portion in the radial direction;
each of the plurality of blades further includes:
   a positive pressure surface that faces the forward side in the rotational direction; and
   a negative pressure surface that faces a backward side in the rotational direction;
in a cross-section of the leading edge portion of each of the plurality of blades taken along a virtual plane perpendicular to the radial direction, the negative pressure surface is formed by at least one line which extends toward the forward side in the rotational direction as the at least one line extends toward the one side in the axial direction;
in the cross-section of the leading edge portion of each of the plurality of blades, the positive pressure surface is formed by at least one of:
   a line that extends toward the forward side in the rotational direction as the line extends toward the one side in the axial direction; and
   a line that extends in parallel with the axis;
an end part of the positive pressure surface of the leading edge portion, which is positioned furthest toward the one side in the axial direction, is defined as a positive pressure surface end part;
an end part of the negative pressure surface of the leading edge portion, which is positioned furthest toward the one side in the axial direction, is defined as a negative pressure surface end part, wherein the leading edge portion includes a convex portion that bulges from a virtual line that connects between the positive pressure surface end part and the negative pressure surface end part; and
a virtual line, which passes through the positive pressure surface end part and extends in the axial direction in the cross-section of the leading edge portion, is defined as a first reference line, and a virtual line, which passes through the negative pressure surface end part and extends in the rotational direction in the cross-section of the leading edge portion, is defined as a second reference line, and the convex portion is disposed on the backward side of the first reference line in the rotational direction and on the another side of the second reference line in the axial direction, the method including:
assembling a first die, a second die, a plurality of third dies and a fourth die together, wherein:
the first die is configured to mold a side of the main plate which faces the another side in the axial direction;
the second die is configured to mold:
   a side of a main plate inner region of the main plate, which faces the one side in the axial direction, wherein the main plate inner region is disposed on the inner side of the plurality of blades in the radial direction;
   the convex portion of each of the plurality of blades;
   the negative pressure surface of the leading edge portion of each of the plurality of blades; and
   a side of each of a plurality of first regions of the main plate which faces the one side in the axial direction, wherein each of the plurality of first regions is disposed on the outer side of the main plate inner region in the radial direction and is joined to the negative pressure surface of the leading edge portion of an adjacent one of the plurality of blades that is adjacent to the first region;
each of the plurality of third dies is configured to mold:
   the positive pressure surface of each of the trailing edge portion and the leading edge portion of one of adjacent two of the plurality of blades that are disposed adjacent to the third die;
   the negative pressure surface of the trailing edge portion of another one of the adjacent two of the plurality of blades;
   a side of a second region of the main plate which is disposed adjacent to the third die and faces the one side in the axial direction, wherein the second region is disposed between the adjacent two of the plurality of blades and is disposed on the outer side of a corresponding one of the plurality of first regions in the radial direction, and the corresponding one of the plurality of first regions is disposed between the adjacent two of the plurality of blades; and
   a side of an adjacent portion of the ring which is adjacent to the third die and faces the another side in the axial direction; and
the fourth die is configured to mold a side of the ring which faces the one side in the axial direction;
injecting a material, which has flowability, into a molding region that is formed by the first die, the second die, the plurality of third dies and the fourth die;
molding an integrated article, which includes the plurality of blades, the ring and the main plate integrated together, in the molding region, by solidifying the material injected into the molding region; and
separating the first die, the second die, the plurality of third dies and the fourth die from the integrated article.

According to this aspect, the convex portion is formed to bulge from the virtual line, which connects between the positive pressure surface end part and the negative pressure surface end part. The convex portion is disposed on the backward side of the first reference line in the rotational direction and on the other side of the second reference line in the axial direction.

Accordingly, it is possible to avoid a state in which the second die becomes caught in the convex portion. Therefore, at the time of separating the second die and the convex portion away from each other in the axial direction, it is possible to avoid interference between the second die and the convex portion. As a result, the first die, the second die, the plurality of third dies and the fourth die can be separated from the integrated article. Thus, it is possible to provide the method for manufacturing the centrifugal fan which enables the integral molding.

According to another aspect of the present disclosure, there is provided a centrifugal fan including:
a plurality of blades that are arranged at intervals in a circumferential direction about an axis;
a ring that is formed in a ring shape and is centered on the axis, wherein a direction, in which the axis extends, is defined as an axial direction, and the ring is joined to the plurality of blades on one side in the axial direction; and
a main plate that has a thickness in the axial direction, wherein the main plate is joined to the plurality of blades on another side in the axial direction, wherein:
when the plurality of blades, the ring and the main plate are rotated together toward a forward side in a rotational direction about the axis, air, which is drawn from the one side in the axial direction, is blown toward an outer side in a radial direction about the axis;
each of the plurality of blades includes a leading edge portion that is disposed on an inner side of the ring in the radial direction about the axis;
each of the plurality of blades further includes:
   a positive pressure surface that faces the forward side in the rotational direction; and
   a negative pressure surface that faces a backward side in the rotational direction;
in a cross-section of the leading edge portion of each of the plurality of blades taken along a virtual plane perpendicular to the radial direction, the negative pressure surface is formed by at least one line which extends toward the forward side in the rotational direction as the at least one line extends toward the one side in the axial direction;
in the cross-section of the leading edge portion of each of the plurality of blades, the positive pressure surface is formed by at least one of:
   a line that extends toward the forward side in the rotational direction as the line extends toward the one side in the axial direction; and
   a line that extends in parallel with the axis;
an end part of the positive pressure surface of the leading edge portion, which is positioned furthest toward the one side in the axial direction, is defined as a positive pressure surface end part;
an end part of the negative pressure surface of the leading edge portion, which is positioned furthest toward the one side in the axial direction, is defined as a negative pressure surface end part, wherein the leading edge portion includes a convex portion that bulges from a virtual line that connects between the positive pressure surface end part and the negative pressure surface end part; and
a virtual line, which passes through the positive pressure surface end part and extends in the axial direction in the cross-section of the leading edge portion, is defined as a first reference line, and a virtual line, which passes through the negative pressure surface end part and extends in the rotational direction in the cross-section of the leading edge portion, is defined as a second reference line, and the convex portion is disposed on the backward side of the first reference line in the rotational direction and on the another side of the second reference line in the axial direction.

According to this aspect, it is possible to provide the centrifugal fan that is suitable for the method for manufacturing the centrifugal fan which enables the integral molding.

Hereinafter, embodiments of the present disclosure will be described with reference to the drawings. For the sake of simplicity of explanation, the same reference signs are assigned to the portions that are the same or equal to each other in the following respective embodiments.

### First Embodiment

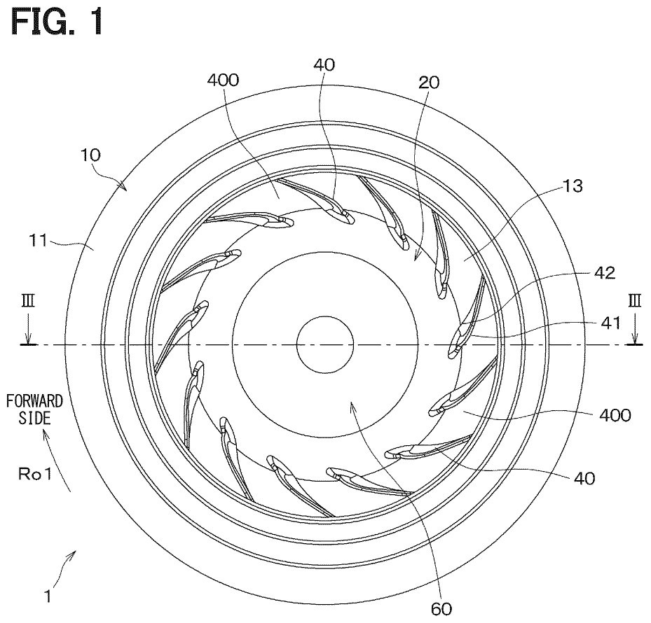

Next, a blower device 1 according to the first embodiment will be described with reference to FIGS. 1 to 7.

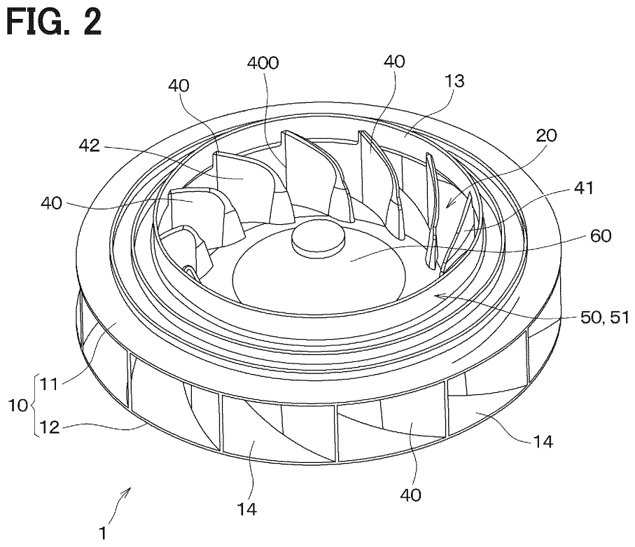

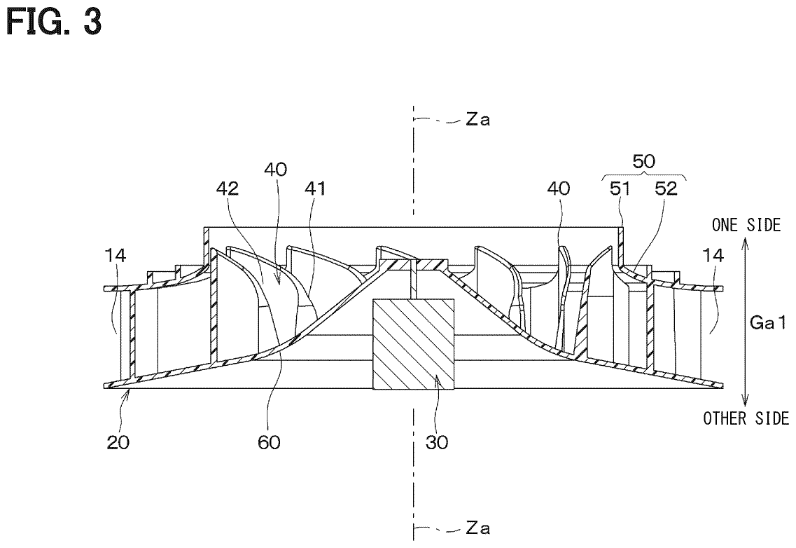

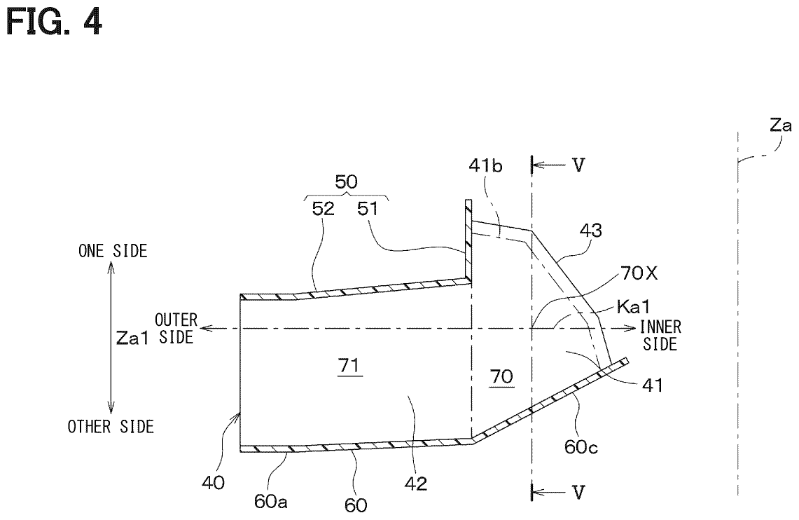

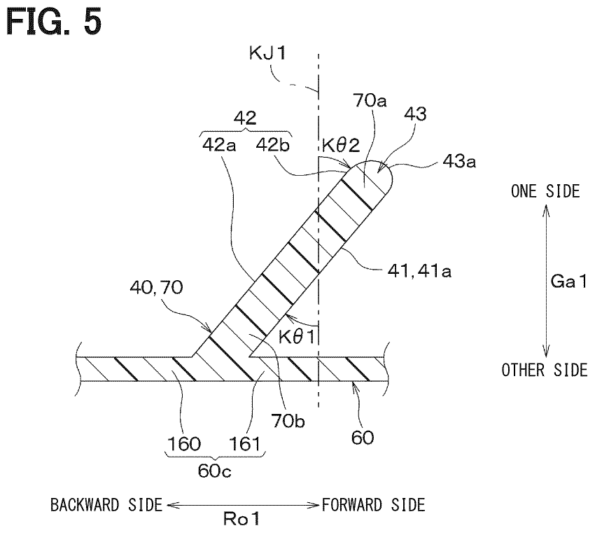

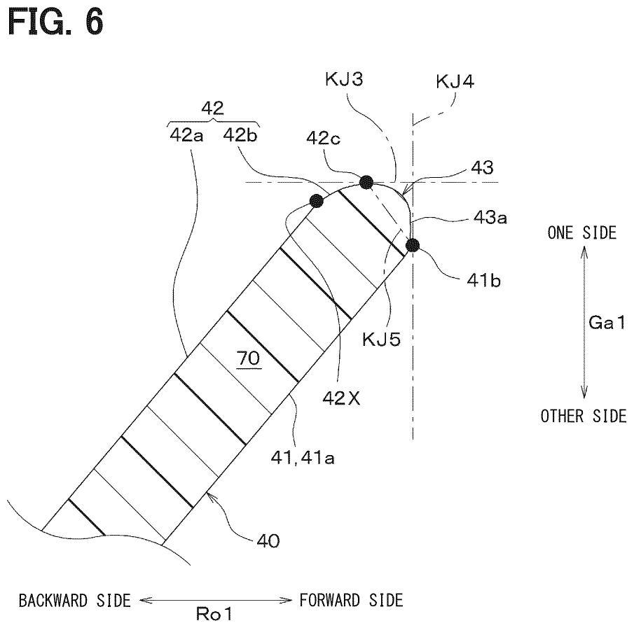

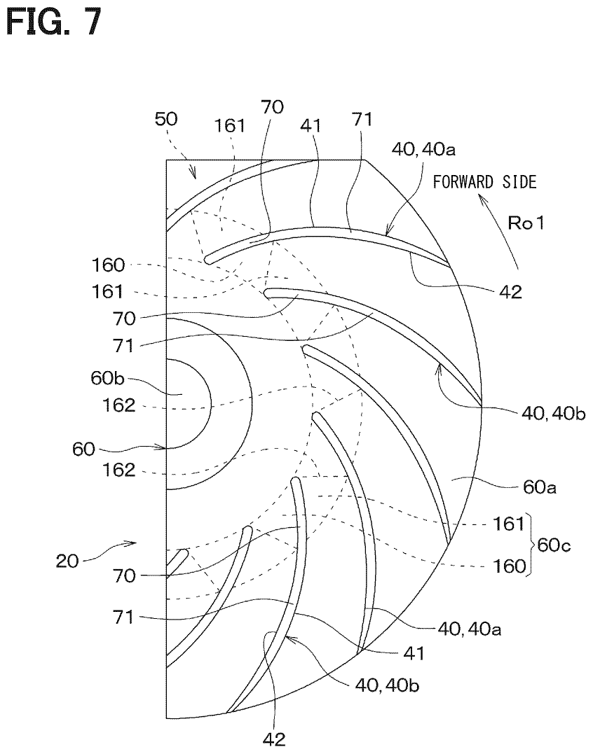

FIG. 1 is a front view of the blower device 1 according to the present embodiment. FIG. 2 is a perspective view of the blower device according to the present embodiment. FIG. 3 is a cross-sectional view taken along line III-III of the blower device 1 in FIG. 1 according to the present embodiment. FIG. 4 is a view showing only one blade 40 among the blades 40 in FIG. 1. FIG. 5 is a cross-sectional view taken along line V-V in FIG. 4. FIG. 6 is an enlarged view of a portion of the blade 40 shown in FIG. 5. FIG. 7 is a transparent view showing a portion of a main plate 60 in a state where a shroud ring 50 of the centrifugal fan 20 in FIG. 1 is viewed through.

The blower device 1 of the present embodiment is a centrifugal blower device that constitutes part of a vehicle air conditioning apparatus. As shown in FIGS. 1, 2, and 3, the blower device 1 of the present embodiment includes a blower casing 10, a centrifugal fan 20 and an electric motor 30.

The blower casing 10 includes an upper casing 11 and a lower casing 12. The upper casing 11 is formed in a circular plate shape centered on the axis Za. The upper casing 11 has an air suction inlet 13 that opens in an axial direction Ga1. The air suction inlet 13 is formed in a circular shape centered on the axis Za.

The lower casing 12 is disposed on the other side of the upper casing 11 in the axial direction Ga1. Each of a plurality of air discharge outlets 14 is provided between the upper casing 11 and the lower casing 12 and faces an outer side in the radial direction Ka1 centered on the axis Za.

In the present embodiment, the air discharge outlets 14 are arranged all around the axis Za in a circumferential direction centered on the axis Za. The upper casing 11 and the lower casing 12 are joined together by a connection (not shown).

The centrifugal fan 20 is disposed between the upper casing 11 and the lower casing 12 of the blower casing 10. As shown in FIG. 3, the centrifugal fan 20 is a turbo fan that includes a plurality of blades 40, the shroud ring 50 and the main plate 60.

Here, the blades 40 are arranged at intervals in the circumferential direction centered on the axis Za. Between each adjacent two of the blades 40, the interval forms an air flow passage 400 through which air flows. Each of the blades 40 is formed such that the blade 40 extends toward a backward side in a rotational direction Ro1 as the blade 40 extends from an inner side toward the outer side in the radial direction Ka1.

Each of the blades 40 includes a positive pressure surface 41 and a negative pressure surface 42. The positive pressure surface 41 is formed on a forward side in the rotational direction Ro1 in each of the blades 40. The forward side in the rotational direction Ro1 is a side toward which the centrifugal fan 20 rotates.

The negative pressure surface 42 is formed on the backward side in the rotational direction Ro1 in each of the blades 40. The backward side in the rotational direction Ro1 is a side opposite to the forward side in the rotational direction Ro1. The blades 40 are formed such that a distance between the positive pressure surface 41 and the negative pressure surface 42 in the air flow passage 400 increases from the inner side toward the outer side in the radial direction Ka1.

The shroud ring 50 is formed in a ring shape and is centered on the axis Za. The shroud ring 50 is disposed on the one side of the blades 40 in the axial direction Ga1. The shroud ring 50 is joined to the blades 40 on the one side in the axial direction Ga1. The shroud ring 50 is used to reinforce the strength of the blades 40. Specifically, the shroud ring 50 includes an outer region 52 and an inner region 51.

The outer region 52 is formed in a ring shape and is centered on the axis Za. The outer region 52 is formed in a plate shape that extends over the radial direction Ka1. The inner region 51 is disposed on the inner side of the outer region 52 in the radial direction Ka1.

The inner region 51 is formed in a cylindrical tubular shape and is centered on the axis Za. The outer region 52 and the inner region 51 are joined together.

Here, as shown in FIG. 4, each of the blades 40 includes a leading edge portion 70 and a trailing edge portion 71. The leading edge portion 70 is disposed on the inner side of the shroud ring 50 in the radial direction Ka1 in each of the blades 40.

The trailing edge portion 71 is disposed on the outer side of the leading edge portion 70 in the radial direction Ka1 in each of the blades 40. That is, in each of the blades 40, the trailing edge portion 71 is disposed on the other side of the shroud ring 50 in the axial direction Ga1.

In the present embodiment, as shown in FIG. 4, the leading edge portion 70 is formed in an inclined shape that is inclined toward the forward side in the rotational direction Ro1 with respect to the axial direction Ga1. As shown in FIG. 5, a one-side section 70a of the leading edge portion 70, which is a section of the leading edge portion 70, is disposed on the forward side in the rotational direction Ro1 with respect to an other-side section 70b of the leading edge portion 70, which is another section of the leading edge portion 70 and is disposed on the other side of the one-side section 70a in the axial direction Ga1.

FIG. 5 is a cross-sectional view of the leading edge portion 70 shown in FIG. 4, taken along a virtual plane that includes an arbitrary point 70X and is perpendicular to the radial direction Ka1. The radial direction Ka1 is a radial direction that passes through the arbitrary point 70X of the leading edge portion 70 shown in FIG. 4. FIG. 6 is an enlarged view of a portion of the leading edge portion 70 shown in FIG. 5.

The positive pressure surface 41 of the leading edge portion 70 is defined in the cross-sectional view of FIG. 5, by a straight line 41a that extends toward the forward side in the rotational direction Ro1 as the straight line 41a extends toward the one side in the axial direction Ga1. When a virtual line (i.e., a first reference line), which intersects the line 41a and extends in the axial direction Ga1, is defined as a reference line KJ1, an inclination angle Kθ1, which is an acute angle formed between the line 41a and the reference line KJ1, is constant throughout an entire range of the positive pressure surface 41 in the rotational direction Ro1.

The negative pressure surface 42 of the leading edge portion 70 is defined in the cross-sectional view of FIG. 5 by two lines 42a, 42b that extend one after another toward the forward side in the rotational direction Ro1 as the lines 42a, 42b extend toward the one side in the axial direction Ga1. The line 42a is formed such that the line 42a extends straight toward the forward side in the rotational direction Ro1 as the line 42a extends from the main plate 60 toward the one side in the axial direction Ga1.

An inclination angle Kθ2, which is an acute angle formed between the line 42a and the reference line KJ1, is constant throughout an entire range of the negative pressure surface 42 in the rotational direction Ro1.

In the present embodiment, the inclination angle Kθ1 of the positive pressure surface 41 is the same as the inclination angle Kθ2 of the negative pressure surface 42. The acute angle is an angle that is equal to or larger than zero degrees and less than 180 degrees.

The line 42b is formed such that the line 42b extends toward the forward side in the rotational direction Ro1 as the line 42b extends from a one-side end part of the line 42a, which faces the one side in the axial direction Ga1, toward the one side in the axial direction Ga1. Specifically, the line 42b is formed in an arcuate shape that bulges outward in the cross-sectional view of FIG. 6. The lines 42a, 42b are connected to each other at a connection 42X.

In the cross-sectional view of the leading edge portion 70 shown in FIG. 6, an end part of the line 41a (i.e., the positive pressure surface 41), which is positioned furthest toward the one side in the axial direction Ga1, is defined as a positive pressure surface end part 41b. In the cross-sectional view of the leading edge portion 70 shown in FIG. 6, an end part of the lines 42a, 42b (i.e., the negative pressure surface 42), which is positioned furthest toward the one side in the axial direction Ga1, is defined as a negative pressure surface end part 42c.

An arcuate convex portion 43 is formed at a portion of the leading edge portion 70, which faces the one side in the axial direction Ga1, such that the arcuate convex portion 43 bulges from the positive pressure surface end part 41b and the negative pressure surface end part 42c to have its outer contour line 43a formed in an arcuate shape in the cross-sectional view of the leading edge portion 70 shown in FIG. 6.

Specifically, a virtual line, which connects between the positive pressure surface end part 41b and the negative pressure surface end part 42c, is defined as a reference line KJ5. In the cross-sectional view of the leading edge portion 70 shown in FIG. 6, the arcuate convex portion 43 is formed so as to bulge from the reference line KJ5.

In the cross-sectional view of FIG. 6, a virtual line, which passes through the negative pressure surface end part 42c of the negative pressure surface 42 and extends in the rotational direction Ro1, is defined as a reference line KJ3. A virtual line, which passes through the positive pressure surface end part 41b of the positive pressure surface 41 and extends in the axial direction Ga1, is defined as a reference line KJ4.

In the present embodiment, in the cross-sectional view of FIG. 6, the arcuate convex portion 43 is disposed on the other side of the reference line KJ3 in the axial direction Ga1. In addition, the arcuate convex portion 43 is disposed on the backward side of the reference line KJ4 in the rotational direction Ro1.

In the present embodiment, the trailing edge portion 71 of each of the blades 40 is formed such that the trailing edge portion 71 is parallel to the axis Za over an entire radial extent of the trailing edge portion 71 in the radial direction Ka1.

As shown in FIGS. 1, 2, and 3, the main plate 60 has a thickness in the axial direction Ga1 and is formed in a circular plate shape centered on the axis Za. The main plate 60 is disposed on the other side of the blades 40 in the axial direction Ga1. The main plate 60 is joined to the blades 40 on the other side in the axial direction Ga1. The main plate 60 is used to reinforce the strength of the blades 40.

As shown in FIG. 7, the main plate 60 includes a main plate outer region 60a, a main plate inner region 60b and a main plate intermediate region 60c. FIG. 7 is a view showing a portion of the main plate 60 in a state where the shroud ring 50 of the centrifugal fan 20 is seen through, and is a view of the blades 40 and a portion of the main plate 60 of the centrifugal fan 20 as viewed from the one side in the axial direction Ga1.

The main plate outer region 60a is an annular region of the main plate 60 that is covered from the one side in the axial direction Ga1 by the shroud ring 50. The main plate outer region 60a is disposed on the outer side of the main plate inner region 60b and the main plate intermediate region 60c of the main plate 60 in the radial direction Ka1.

The main plate inner region 60b is a circular-plate shaped region of the main plate 60 that is disposed on the inner side of the blades 40 in the radial direction Ka1. The main plate inner region 60b is disposed on the inner side of the shroud ring 50 of the main plate 60 in the radial direction Ka1.

The main plate inner region 60b is disposed on the inner side of the main plate intermediate region 60c and the main plate outer region 60a in the radial direction Ka1 in the main plate 60. The main plate intermediate region 60c is an annular region of the main plate 60 disposed between the main plate outer region 60a and the main plate inner region 60b.

The main plate intermediate region 60c includes a plurality of intermediate inner regions 160 and a plurality of intermediate outer regions 161. Each of the intermediate inner regions 160 is joined to the negative pressure surface 42 of the leading edge portion 70 of an adjacent one of the blades 40 in the main plate intermediate region 60c of the main plate 60. Each of the intermediate outer regions 161 is joined to the positive pressure surface 41 of the leading edge portion 70 of an adjacent one of the blades 40 in the main plate intermediate region 60c of the main plate 60.

As shown in FIG. 3, a rotatable shaft of the electric motor 30 of the present embodiment is coupled to the main plate 60 of the centrifugal fan 20. The electric motor 30 applies a rotational force to the main plate 60 of the centrifugal fan 20 through its rotatable shaft. The electric motor 30 is disposed between the lower casing 12 and the main plate 60. The electric motor 30 is supported by the lower casing 12.

Next, the operation of the blower device 1 according to the present embodiment will be described.

First, the centrifugal fan 20 is driven by the electric motor 30 to rotate about the axis Za.

Then, the centrifugal fan 20 draws the air from the one side in the axial direction Ga1 through the air suction inlet 13 of the blower casing 10 into the air flow passages 400 and blows the drawn air from the air flow passages 400 toward the outer side in the radial direction Ka1. The air, which is blown out from the air flow passages 400, is discharged from the air discharge outlets 14 of the blower casing 10.

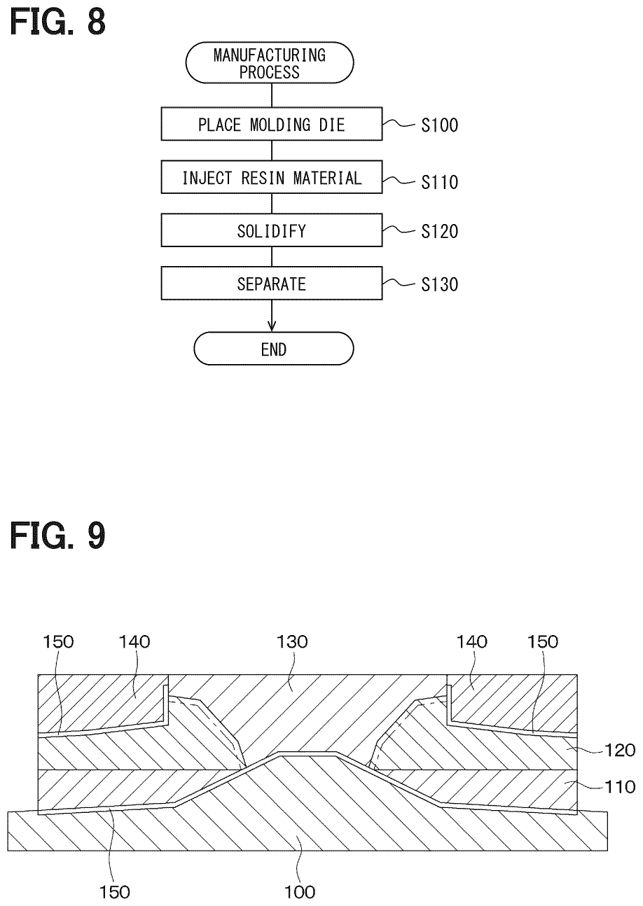

Next, a manufacturing method of the centrifugal fan 20 according to the present embodiment will be described with reference to FIGS. 8 to 13.

FIG. 8 is a flowchart for illustrating details of the manufacturing method for resin-molding the centrifugal fan 20. FIG. 9 is a view showing a state in which a lower die 100, a plurality of lower slide dies 110, a plurality of upper slide dies 120, an axial core die 130, and a ring die 140 are assembled together in a die placement step at S100 in FIG. 8.

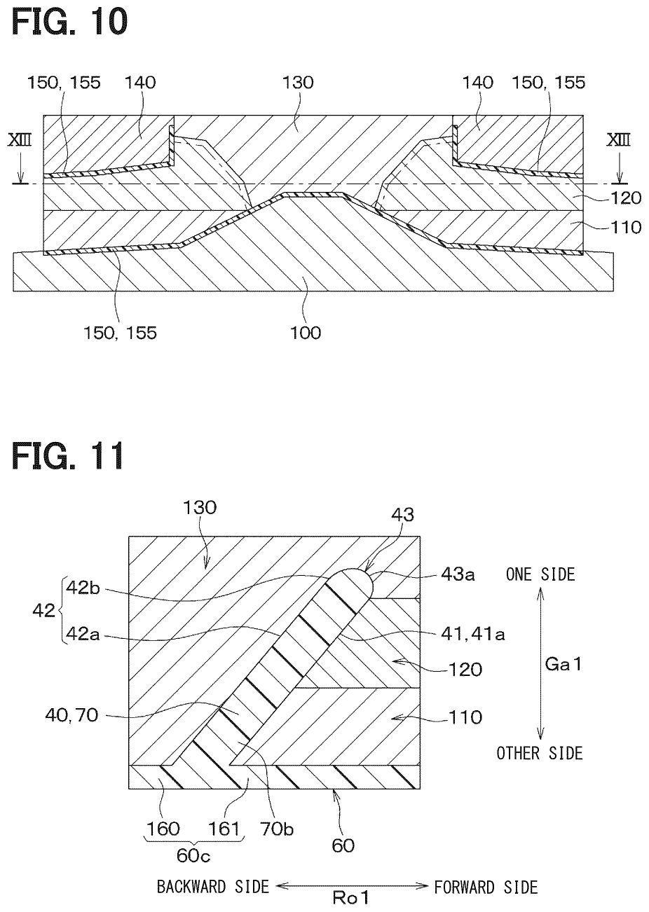

FIG. 10 is a view showing a state in which an integrated article 155 is formed in a molding region 150, which is defined by the lower die 100, the lower slide dies 110, the upper slide dies 120, the axial core die 130 and the ring die 140. FIG. 11 is a view corresponding to FIG. 5, for supplementing the explanation of roles of the lower slide dies 110, the upper slide dies 120 and the axial core die 130.

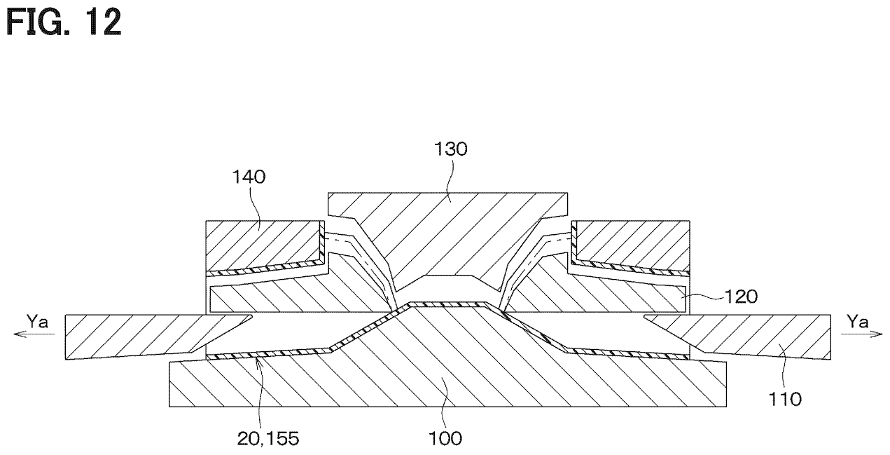

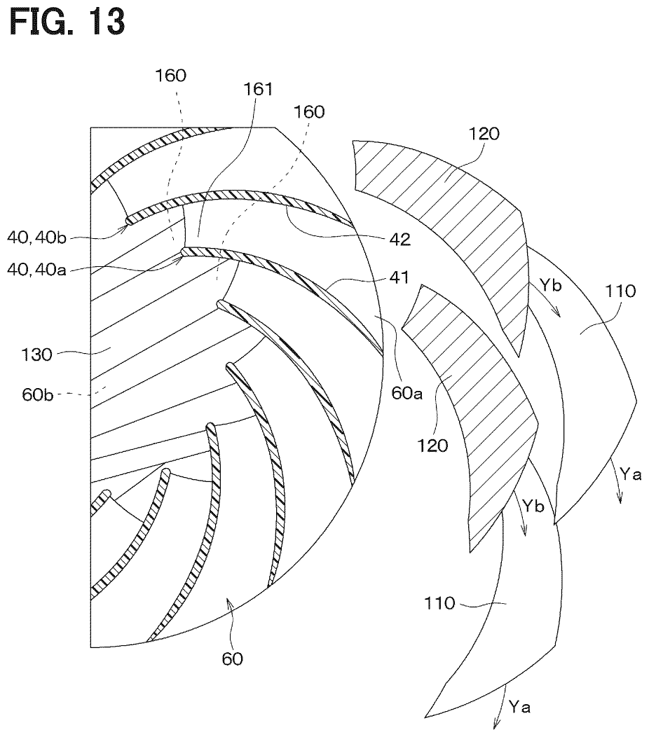

FIG. 12 is a view for illustrating separation of the lower slide dies 110, the upper slide dies 120 and the axial core die 130 from the integrated article 155. FIG. 13 is a view for illustrating separation of the lower slide dies 110 and the upper slide dies 120 from the integrated article 155.

Hereinafter, for convenience of explanation, among each adjacent two of the blades 40, one blade 40, which is disposed on the forward side of the other blade 40 in the rotational direction Ro1, is also referred to as a front blade 40a. Among each adjacent two of the blades 40, the other blade 40, which is disposed on the backward side of the one blade 40 in the rotational direction Ro1, is also referred to as a rear blade 40b.

First, in the die placement step at S100, the lower die 100, the lower slide dies 110, the upper slide dies 120, the axial core die 130 and the ring die 140 are prepared and assembled together.

Here, the lower die 100 serves as a first die that molds a side of the main plate 60, which faces the other side in the axial direction Ga1. The lower slide dies 110 are arranged in the circumferential direction centered on the axis Za and serve as a plurality of third dies.

Each of the lower slide dies 110 molds: the positive pressure surface 41 of each of the leading edge portion 70 and the trailing edge portion 71 of the rear blade 40b; and the negative pressure surface 42 of the trailing edge portion 71 of the corresponding front blade 40a.

Each of the lower slide dies 110 also molds: a side of a corresponding portion of the main plate outer region 60a, which corresponds to this lower slide die 110 and faces the one side in the axial direction Ga1; and a side of the corresponding intermediate outer region 161, which corresponds to the lower slide die 110 and faces the one side in the axial direction Ga1.

As shown in FIG. 7, the intermediate outer region 161 is a connecting region of the main plate intermediate region 60c, which is joined to the positive pressure surface 41 of the leading edge portion 70 of the corresponding rear blade 40b. Each of the intermediate outer regions 161 and the corresponding adjacent portion of the main plate outer region 60a, which is adjacent to this intermediate outer region 161, cooperate together to serve as a second region. The intermediate outer region 161 and the corresponding adjacent portion of the main plate outer region 60a are disposed on the outer side of the adjacent intermediate inner region 160, which will be described later, in the radial direction Ka1.

Each of the upper slide dies 120 and the corresponding one of the lower slide dies 110 cooperate together to serve as the third die. Each of the upper slide dies 120 is disposed on the one side of the corresponding one of the lower slide dies 110, in the axial direction Ga1.

Each of the upper slide dies 120 molds: the positive pressure surface 41 of each of the leading edge portion 70 and the trailing edge portion 71 of the corresponding rear blade 40b; and the negative pressure surface 42 of the trailing edge portion 71 of the corresponding front blade 40a. Each of the upper slide dies 120 molds a side of an adjacent portion of the shroud ring 50, which faces the other side in the axial direction Ga1 and is adjacent to the upper slide ring 120.

As shown in FIGS. 11 and 13, the axial core die 130 serves as a second die that molds: a side of the main plate inner region 60b and a side of each of the intermediate inner regions 160, which faces the one side in the axial direction Ga1; and the arcuate convex portion 43 of each of the blades 40.

As shown in FIG. 7, each of the intermediate inner regions 160 serves as a first region of the main plate intermediate region 60c, which is joined to the negative pressure surface 42 of the leading edge portion 70 of the corresponding front blade 40a. Here, each of the intermediate inner regions 160 is disposed on the inner side of the adjacent intermediate outer region 161 in the radial direction Ka1.

The intermediate inner regions 160 are connected to the main plate inner region 60b. At the location between the positive pressure surface 41 of the corresponding rear blade 40b and the negative pressure surface 42 of the corresponding front blade 40a in the main plate 60, the corresponding adjacent portion of the main plate outer region 60a and the intermediate outer region 161 are disposed on the outer side of the corresponding intermediate inner region 160 in the radial direction Ka1.

Each intermediate inner region 160 and the adjacent intermediate outer region 161 are divided by a corresponding boundary line 162. The boundary line 162 is a line that connects between: a radially inner end part of the corresponding rear blade 40b, which faces the inner side in the radial direction Ka1; and a radially outer end part of the leading edge portion 70, which faces the outer side in the radial direction Ka1 in the corresponding front blade 40a.

The ring die 140 serves as a fourth die that is formed in a ring shape centered on the axis Za. The ring die 140 molds a side of the shroud ring 50, which faces the one side in the axial direction Ga1.

The molding region 150, which is configured to mold the centrifugal fan 20, is formed by assembling the lower die 100, the lower slide dies 110, the upper slide dies 120, the axial core die 130 and the ring die 140 together.

The molding region 150 is a region surrounded by the lower die 100, the lower slide dies 110, the upper slide dies 120, the axial core die 130 and the ring die 140.

Next, in a resin injection step at S110, a resin material, which has flowability, is injected into the molding region 150 through an injection hole (not shown).

Next, in a solidification step at S120, the resin material in the molding region 150 is solidified. Thus, the integrated article 155 is molded in the molding region 150. The integrated article 155 is an article in which the blades 40, the shroud ring 50 and the main plate 60 are integrated in one-piece.

In the solidification step at S120, each of the lower slide dies 110 is disposed between the positive pressure surface 41 of each of the leading edge portion 70 and the trailing edge portion 71 of the corresponding front blade 40a, and the negative pressure surface 42 of the trailing edge portion 71 of the corresponding rear blade 40b. Each of the upper slide dies 120 molds: the positive pressure surface 41 of each of the leading edge portion 70 and the trailing edge portion 71 of the corresponding rear blade 40b; and the negative pressure surface 42 of the trailing edge portion 71 of the corresponding front blade 40a.

Next, in a separation step at S130, the integrated article 155 is separated from the lower die 100, the lower slide dies 110, the upper slide dies 120, the axial core die 130 and the ring die 140.

At this time, each of the lower slide dies 110 is removed, as indicated by an arrow Ya in FIGS. 12 and 13, from between the corresponding adjacent two blades 40 among the blades 40. Thereafter, each of the upper slide dies 120 is removed, as indicated by an arrow Yb in FIG. 13, from between the corresponding adjacent two of the blades 40.

Furthermore, the axial core die 130 and the ring die 140 are also moved toward the one side in the axial direction Ga1 with respect to the integrated article 155. The lower die 100 is moved relative to the integrated article 155 toward the other side in the axial direction Ga1. Thus, the centrifugal fan 20 as the integrated article 155 is injection-molded.

According to the present embodiment described above, the centrifugal fan 20 includes the blades 40 which are arranged at the intervals, each of which serves as the air flow passage 400, in the circumferential direction centered on the axis Za. The centrifugal fan 20 includes the shroud ring 50. The shroud ring 50 is formed in the ring shape centered on the axis Za and is joined to the blades 40 on the one side in the axial direction Ga1, when the direction, in which the axis Za extends, is defined as the axial direction Ga1.

The centrifugal fan 20 includes the main plate 60 that has the thickness in the axial direction Ga1. The main plate 60 is disposed on the other side of the blades 40 in the axial direction Ga1 and is joined to the blades 40 on the other side in the axial direction Ga1. The blades 40, the shroud ring 50 and the main plate 60 form the integrated article 155 which is formed integrally in one-piece.

The blades 40, the shroud ring 50 and the main plate 60 rotate toward the forward side in the rotational direction Ro1 about the axis Za to draw the air into the air flow passages 400 from the one side in the axial direction Ga1 and blow the air from the air flow passages 400 toward the outer side in the radial direction Ka1 about the axis Za.

Each of the blades 40 includes the leading edge portion 70 disposed on the inner side of the shroud ring 50 in the radial direction Ka1.

Each of the blades 40 further includes the positive pressure surface 41, which faces the forward side in the rotational direction Ro1, and the negative pressure surface 42, which faces the backward side in the rotational direction Ro1.

FIG. 6 is a cross-sectional view of the leading edge portion 70 of FIG. 4, taken along the virtual plane that includes the arbitrary point 70X and is perpendicular to the radial direction Ka1. As shown in FIG. 6, the positive pressure surface 41 of the leading edge portion 70 is defined by the line 41a that extends toward the forward side in the rotational direction Ro1 as the line 41a extends toward one side in the axial direction Ga1.

The negative pressure surface 42 of the leading edge portion 70 is defined in the cross-sectional view of FIG. 5 by the lines 42a, 42b that extend toward the forward side in the rotational direction Ro1 as the lines 42a, 42b extend toward the one side in the axial direction Ga1.

In the cross-section of FIG. 6, the end part of the positive pressure surface 41 of the leading edge portion 70, which is positioned furthest toward the one side in the axial direction Ga1, is defined as the positive pressure surface end part 41b, and the end part of the negative pressure surface 42 of the leading edge portion 70, which is positioned furthest toward the forward side in the rotational direction Ro1, is defined as the negative pressure surface end part 42c.

The leading edge portion 70 has the arcuate convex portion 43. The arcuate convex portion 43 bulges from the reference line KJ5, which connects between the positive pressure surface end part 41b and the negative pressure surface end part 42c, to have its outer contour line 43a formed in the arcuate shape in the cross-section of FIG. 6.

In the cross-section of FIG. 6, the virtual line (i.e., the first reference line), which passes through the positive pressure surface end part 41b and extends in the axial direction Ga1, is defined as the reference line KJ4. In the cross-section of FIG. 6, the virtual line (i.e., a second reference line), which passes through the negative pressure surface end part 42c and extends in the rotational direction Ro1, is defined as the reference line KJ3.

The arcuate convex portion 43 is disposed on the other side of the reference line KJ3 in the axial direction Ga1 and on the backward side of the reference line KJ4 in the rotational direction Ro1.

Furthermore, the method for manufacturing the centrifugal fan 20 according to the present embodiment includes the step at S100, in which the lower die 100, the lower slide dies 110, the upper slide dies 120, the axial core die 130 and the ring die 140 are assembled together.

The lower die 100 is the die that molds the side of the main plate 60, which faces the other side in the axial direction Ga1. The axial core die 130 is the die that molds: the side of the main plate inner region 60b, which faces the one side in the axial direction Ga1; the side of each of the intermediate inner regions 160, which faces the one side in the axial direction Ga1; the arcuate convex portion 43 of the leading edge portion 70 of each of the blades 40; and the negative pressure surface 42 of the leading edge portion 70 of each of the blades 40.

The main plate inner region 60b is the region of the main plate 60 that is disposed on the inner side of the blades 40 in the radial direction Ka1. Each of the intermediate inner regions 160 is the first region of the main plate 60, which is disposed on the outer side of the main plate inner region 60b in the radial direction Ka1 in the main plate 60 and is joined to the negative pressure surface 42 of the leading edge portion 70 of the adjacent one of the blades 40.

Each of the lower slide dies 110 molds: the positive pressure surface 41 of each of the leading edge portion 70 and the trailing edge portion 71 of the adjacent one of the blades 40; the negative pressure surface 42 of the trailing edge portion 71 of the other adjacent one of the blades 40; and the corresponding portion of the side of main plate outer region 60a which faces the one side in the axial direction Ga1.

The main plate outer region 60a is the region of the main plate 60 that is covered from the one side in the axial direction Ga1 by the shroud ring 50. Each of the lower slide dies 110 molds the side of the corresponding one of the intermediate outer region 161, which faces the one side in the axial direction Ga1.

Each of the intermediate outer regions 161 and the corresponding adjacent portion of the main plate outer region 60a, which is adjacent to this intermediate outer region 161, cooperate together to serve the second region. At the location between the positive pressure surface 41 of the corresponding rear blade 40b and the negative pressure surface 42 of the corresponding front blade 40a in the main plate 60, the corresponding adjacent portion of the main plate outer region 60a and the intermediate outer region 161 are disposed on the outer side of the corresponding intermediate inner region 160 in the radial direction Ka1.

Each of the upper slide dies 120 molds: the positive pressure surface 41 of each of the leading edge portion 70 and the trailing edge portion 71 of the rear blade 40b; the negative pressure surface 42 of the trailing edge portion 71 of the front blade 40a; and the side of the adjacent portion of the shroud ring 50 which is adjacent to the upper slide die 120 and faces the other side in the axial direction Ga1. The ring die 140 molds a side of the shroud ring 50, which faces the one side in the axial direction Ga1.

Furthermore, the method for manufacturing the centrifugal fan 20 includes the injection step at S110, in which the resin material, which has the flowability, is injected into the molding region 150 that is defined by the lower die 100, the lower slide dies 110, the upper slide dies 120, the axial core die 130 and the ring die 140.

The method for manufacturing the centrifugal fan 20 includes the step at S120, in which the integrated article 155, which includes the blades 40, the shroud ring 50 and the main plate 60 integrated together in one-piece, is molded by solidifying the material injected into the molding region 150.

The method for manufacturing the centrifugal fan 20 includes the step at S130, in which the lower die 100, the lower slide dies 110, the upper slide dies 120, the axial core die 130 and the ring die 140 are separated from the integrated article 155.

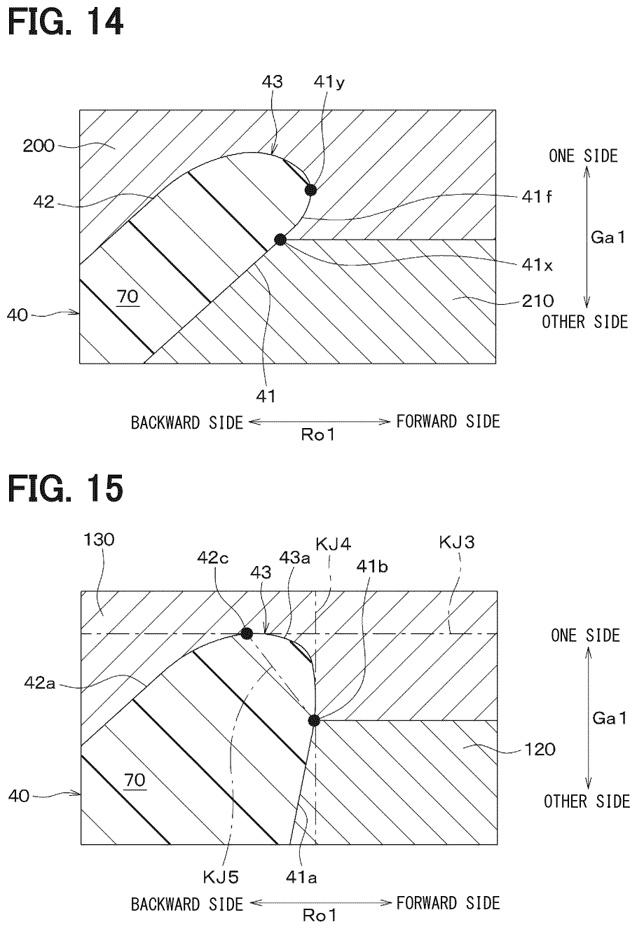

Here, for comparative purposes, it is assumed that, for example, as shown in FIG. 14, a part of the leading edge portion 70 of the blade 40, which is positioned furthest toward the forward side in the rotational direction Ro1, is defined as a foremost part 41y. Also, a part of the arcuate convex portion 43, which faces the forward side in the rotational direction Ro1 and is positioned furthest toward the other side in the axial direction Ga1 in the arcuate convex portion 43, is defined as a lowermost part 41x. Furthermore, a region of the arcuate convex portion 43, which faces the forward side in the rotational direction Ro1 and is located on the one side of the lowermost part 41x in the axial direction Ga1, is defined as a positive pressure upper region 41f.

Here, the upper die 200 molds the negative pressure surface 42 of the leading edge portion 70 of each of the blades 40 and the arcuate convex portion 43 of each of the blades 40, and the lower die 210 molds the positive pressure surface 41 of the leading edge portion 70 of each of the blades 40. In particular, the positive pressure upper region 41f of the arcuate convex portion 43 is molded by the upper die 200.

In this case, the foremost part 41y of the leading edge portion 70 is disposed on the one side of the lowermost part 41x in the axial direction Ga1. Furthermore, in a state where the resin material injected into the molding region between the upper die 200 and the lower die 210 is solidified, as shown in FIG. 14, the upper die 200 is fitted to the positive pressure upper region 41f of the leading edge portion 70.

Therefore, when the upper die 200 is moved toward the one side in the axial direction Ga1 relative to the leading edge portion 70 in order to separate the upper die 200 from the leading edge portion 70, the upper die 200 interferes with the positive pressure upper region 41f of the leading edge portion 70.

As a result, the upper die 200 cannot be separated from the leading edge portion 70. Therefore, the centrifugal fan 20 cannot be integrally molded.

In contrast, according to the present embodiment, as shown in FIG. 15, the arcuate convex portion 43 bulges from the reference line KJ5, which connects between the positive pressure surface end part 41b and the negative pressure surface end part 42c, to have the outer contour line 43a that is formed in the arcuate shape. FIG. 15 is a cross-sectional view showing a part of the centrifugal fan 20 molded by the lower slide die 110, the upper slide die 120 and the axial core die 130.

Similar to FIG. 5, FIG. 15 is a cross-sectional view of the leading edge portion 70 of the blade 40, taken along the virtual plane that includes the arbitrary point of the leading edge portion 70 and is perpendicular to the radial direction. FIG. 15 shows the leading edge portion 70 molded by the lower slide die 110, the upper slide die 120 and the axial core die 130 in a manufacturing process of injection molding. The virtual line, which passes through the negative pressure surface end part 42c of the negative pressure surface 42 and extends in the rotational direction Ro1, is defined as the reference line KJ3.

The virtual line, which passes through the positive pressure surface end part 41b of the positive pressure surface 41 and extends in the axial direction Ga1, is defined as the reference line KJ4. In the present embodiment, in the cross-sectional view of FIG. 6, the arcuate convex portion 43 is disposed on the other side of the reference line KJ3 in the axial direction and on the backward side of the reference line KJ4 in the rotational direction Ro1.

Therefore, the axial core die 130 does not become caught in the arcuate convex portion 43 of the leading edge portion 70 of the blade 40. Accordingly, when the axial core die 130 is moved toward the one side in the axial direction Ga1, the axial core die 130 does not interfere with the blade 40.

Thus, the blades 40 can be separated from the axial core die 130. Therefore, the integrated article 155 can be satisfactorily separated from the lower die 100, the lower slide dies 110, the upper slide dies 120, the axial core die 130 and the ring die 140.

Thus, it is possible to provide the method for manufacturing the centrifugal fan 20 and the centrifugal fan 20 which enable the integral molding.

In the present embodiment configured as described above, the following advantages (a), (b) and (c) can be obtained.
(a) The axial core die 130 molds: the side of the main plate inner region 60b, which faces the one side in the axial direction Ga1; the side of each of the intermediate inner regions 160, which faces the one side in the axial direction Ga1; and the arcuate convex portion 43 of each of the blades 40.

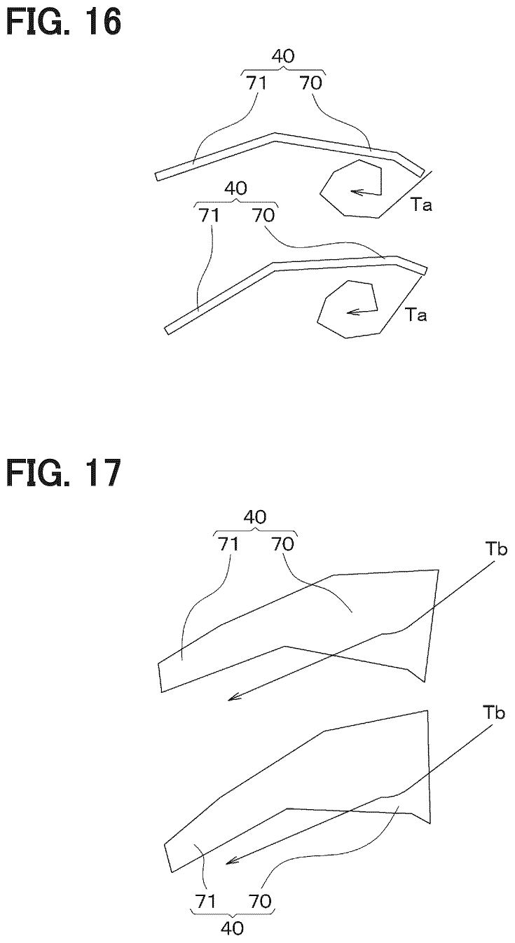

Therefore, the number of the dies can be reduced compared with a case where the side of the main plate inner region 60b, which faces the one side in the axial direction Ga1, the side of each of the intermediate inner regions 160, which faces the one side in the axial direction Ga1, and the arcuate convex portion 43 of each of the blades 40 are molded by separate dies. Accordingly, the manufacturing management of the centrifugal fan 20 can be simplified.
(b) Each of the lower slide dies 110 and the corresponding one of the upper slide dies 120 are provided to mold the positive pressure surface 41 of the corresponding rear blade 40b and the negative pressure surface 42 of the corresponding front blade 40a. Therefore, the lower slide die 110 and the upper slide die 120 can be satisfactorily separated from the rear blade 40b and the front blade 40a.
(c) As shown in FIG. 16, in a case where the positive pressure surface 41 and the negative pressure surface 42 of the front blade 40a are parallel to the axis Za, the air separates from the positive pressure surface 41 and the negative pressure surface 42, as indicated by an arrow Ta in FIG. 16. In contrast, in the present embodiment, the positive pressure surface 41 and the negative pressure surface 42 of the front blade 40a are formed so as to extend toward the forward side in the rotational direction Ro1 as they extend toward the one side in the axial direction Ga1. Therefore, as shown in FIG. 17, it is possible to suppress the air from separating from the positive pressure surface 41 and the negative pressure surface 42, as indicated by an arrow Tb in FIG. 17.

### Second Embodiment

In the first embodiment described above, there is explained the example in which, in the cross-sectional view of the leading edge portion 70 of the blade 40 shown in FIG. 5, the positive pressure surface 41 is defined by the line 41a.

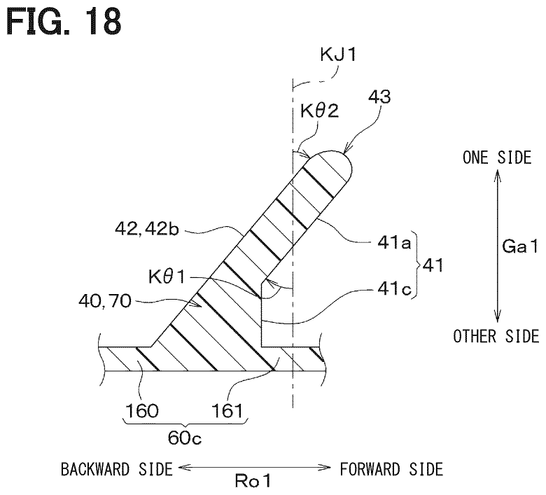

However, instead, there will be described an example, in which, in the cross-sectional view of FIG. 18, the positive pressure surface 41 is defined by two lines 41a, 41c. In FIG. 18, the same reference signs as those used in FIG. 5 denote the same components, and a detailed description thereof is omitted.

FIG. 18 is a cross-sectional view of the leading edge portion 70 of the blade 40, taken along a virtual plane perpendicular to the radial direction Ka1, and corresponds to the cross-sectional view of FIG. 5 in the first embodiment.

As shown in FIG. 18, the positive pressure surface 41 is defined by the lines 41a, 41c. The line 41c is disposed between the line 41a and the intermediate outer region 161 of the main plate intermediate region 60c.

The line 41c is a straight line segment that extends in the axial direction Ga1. That is, the line 41c is a line segment formed parallel to the axis Za. The line 41a is disposed between the line 41c and the arcuate convex portion 43. The line 41a is formed such that the line 41a extends toward the forward side in the rotational direction Ro1 as the line 41a extends toward the one side in the axial direction Ga1.

Here, an inclination angle, which is an acute angle formed between the line 41c and the reference line KJ1, is zero. Therefore, an inclination angle formed between the line 41a and the reference line KJ1 is different from the inclination angle formed between the line 41c and the reference line KJ1. Specifically, the inclination angle formed between the line 41a and the reference line KJ1 is larger than the inclination angle formed between the line 41c and the reference line KJ1.

According to the present embodiment described above, similarly to the first embodiment described above, it is possible to provide the method for manufacturing the centrifugal fan 20 and the centrifugal fan 20 which enable the integral molding.

In the present embodiment, in the positive pressure surface 41 of the blade 40, the line 41c is formed parallel to the axis Za. The line 41a is formed such that the line 41a extends toward the forward side in the rotational direction Ro1 as the line 41a extends toward the one side in the axial direction Ga1. Therefore, the inclination of the positive pressure surface 41 of the blade 40 can be matched to the airflow flowing through the air flow passage 400. Thus, it is possible to reduce the pressure loss generated when the air flows through the air flow passage 400.

### Third Embodiment

In the second embodiment described above, there is described the example, in which in the positive pressure surface 41 of the cross-sectional view of FIG. 18, the line 41c is the straight line segment which extends in the axial direction Ga1.

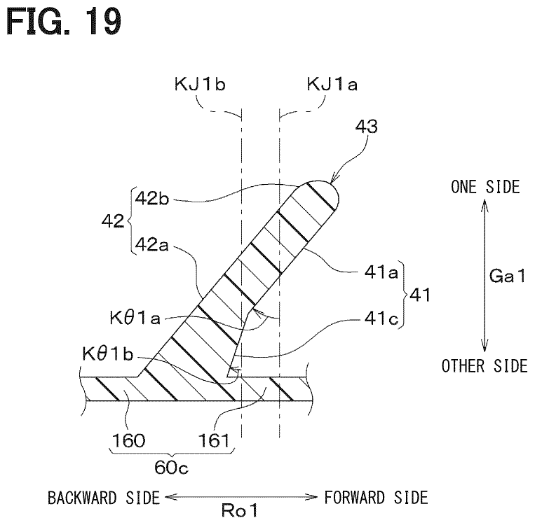

However, instead, there will be described an example with reference to FIG. 19, in which the line 41c is formed as a line segment which extends toward the forward side in the rotational direction Ro1 as the line 41c extends toward the one side in the axial direction Ga1. In FIG. 19, the same reference signs as those used in FIG. 18 denote the same components, and a detailed description thereof is omitted.

FIG. 19 is a cross-sectional view of the leading edge portion 70 of the blade 40, taken along a virtual plane perpendicular to the radial direction Ka1, and corresponds to the cross-sectional view of FIG. 18 in the second embodiment.

As shown in FIG. 19, the positive pressure surface 41 is defined by the lines 41a, 41c. The line 41c is disposed between the line 41a and the intermediate outer region 161.

The line 41a is a first line segment that extends toward the forward side in the rotational direction Ro1 as the line 41a extends toward the one side in the axial direction Ga1. The line 41c is a second line segment that extends toward the forward side in the rotational direction Ro1 as the line 41c extends toward the one side in the axial direction Ga1.

Here, an inclination angle (i.e., a first inclination angle) Kθ1a, which is formed between the line 41a and the reference line KJ1a, is larger than an inclination angle Kθ1b formed between the line 41c and the reference line KJ1b. The inclination angle (i.e., a second inclination angle) Kθ1b, which is an acute angle formed between the line 41c and the reference line KJ1b, is larger than zero.

The reference line KJ1a is a third reference line that extends in the axial direction Ga1 and intersects the line 41a. The reference line KJ1b is a fourth reference line that extends in the axial direction Ga1 and intersects the line 41c. According to the present embodiment described above, similarly to the second embodiment described above, it is possible to provide the method for manufacturing the centrifugal fan 20 and the centrifugal fan 20 which enable the integral molding.

In the present embodiment, in the positive pressure surface 41 of the blade 40, the inclination angle Kθ1a, which is formed between the line 41a and the reference line KJ1a, is larger than the inclination angle Kθ1b, which is formed between the line 41c and the reference line KJ1b. Therefore, the inclination of the positive pressure surface 41 of the blade 40 can be matched to the airflow flowing through the air flow passage 400. Thus, it is possible to reduce the pressure loss generated when the air flows through the air flow passage 400.

### Fourth Embodiment

In the third embodiment described above, there is described the example, in which in the positive pressure surface 41 in the cross-sectional view of FIG. 19, the line 41c is disposed on the other side of the line 41a in the axial direction Ga1.

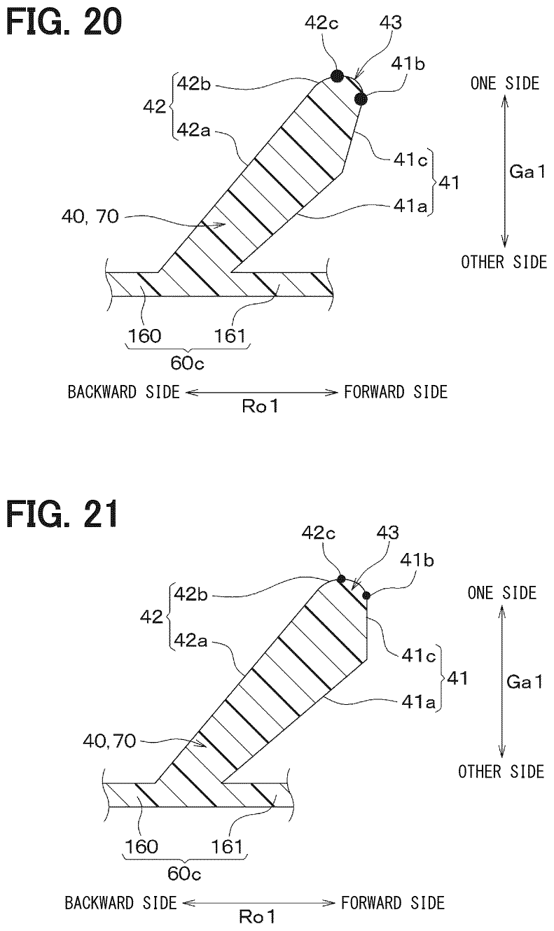

However, instead, there will be described an example with reference to FIG. 20, in which the line 41c is disposed on the one side of the line 41a in the axial direction Ga1.

FIG. 20 is a cross-sectional view of the leading edge portion 70 of the blade 40, taken along a virtual plane perpendicular to the radial direction Ka1, and corresponds to the cross-sectional view of FIG. 19 in the third embodiment.

As shown in FIG. 20, the positive pressure surface 41 is defined by the lines 41a, 41c. The line 41c is disposed between the arcuate convex portion 43 and the line 41a.

The line 41c is formed such that the line 41c extends toward the forward side in the rotational direction Ro1 as the line 41c extends toward the one side in the axial direction Ga1. The line 41a is formed such that the line 41a extends toward the forward side in the rotational direction Ro1 as the line 41a extends toward the one side in the axial direction Ga1.

Here, an inclination angle, which is an acute angle formed between the line 41c and the reference line KJ1, is larger than zero. The inclination angle formed between the line 41a and the reference line KJ1 is larger than the inclination angle formed between the line 41c and the reference line KJ1.

According to the present embodiment described above, similarly to the third embodiment described above, it is possible to provide the method for manufacturing the centrifugal fan 20 and the centrifugal fan 20 which enable the integral molding.

In the present embodiment, in the positive pressure surface 41 of the blade 40, the inclination angle, which is formed between the line 41a and the reference line KJ1, is larger than the inclination angle, which is formed between the line 41c and the reference line KJ1. Therefore, the inclination of the positive pressure surface 41 of the blade 40 can be matched to the airflow flowing through the air flow passage 400. Thus, it is possible to reduce the pressure loss generated when the air flows through the air flow passage 400.

### Fifth Embodiment

In the fourth embodiment described above, there is described the example, in which, in the positive pressure surface 41 of the leading edge portion 70, the line 41c, which is disposed on the one side of the line 41a in the axial direction Ga1, is formed such that the line 41c extends toward the forward side in the rotational direction Ro1 as the line 41c extends toward the one side in the axial direction Ga1.

However, in the fifth embodiment, instead, with reference to FIG. 21, there will be described an example, in which, in the cross-section of the positive pressure surface 41 of the leading edge portion 70, the line 41c is formed such that the line 41c is parallel to the axis Za.

FIG. 21 is a cross-sectional view of the leading edge portion 70 of the blade 40, taken along a virtual plane perpendicular to the radial direction Ka1, and corresponds to the cross-sectional view of FIG. 20 in the fourth embodiment.

As shown in FIG. 21, the positive pressure surface 41 is defined by the lines 41a, 41c. The line 41c is disposed between the arcuate convex portion 43 and the line 41a.

The line 41c is formed to be parallel to the axis Za. The line 41a is formed such that the line 41a extends toward the forward side in the rotational direction Ro1 as the line 41a extends toward the one side in the axial direction Ga1.

According to the present embodiment described above, similarly to the third embodiment described above, it is possible to provide the method for manufacturing the centrifugal fan 20 and the centrifugal fan 20 which enable the integral molding.

### Sixth Embodiment

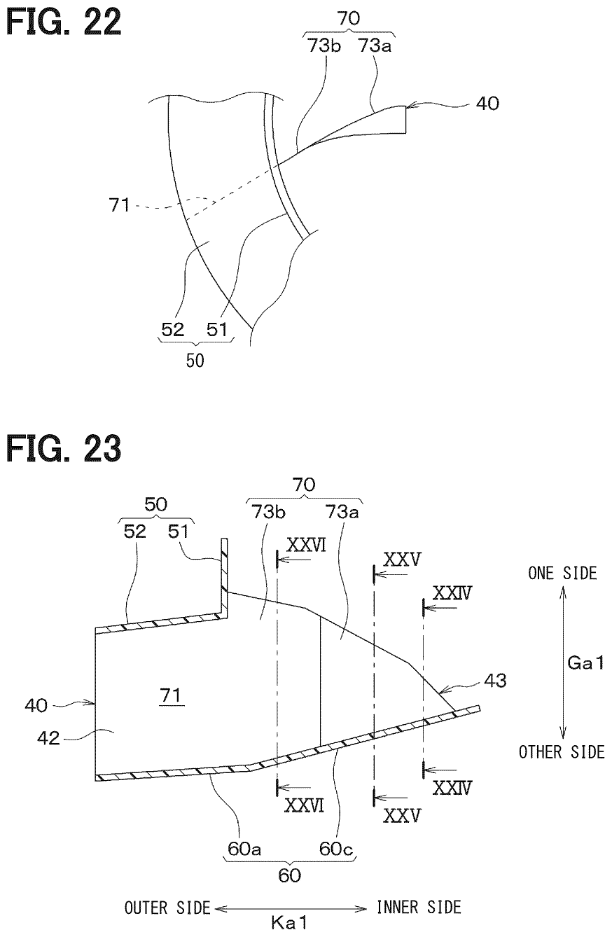

In the sixth embodiment, with reference to FIGS. 22, 23, 24 and 25, there will be described an example, in which the inclination angle of the negative pressure surface 42 of the leading edge portion 70 of the blade 40 in the first embodiment decreases as the negative pressure surface 42 extends from the outer side toward the inner side in the radial direction Ka1.

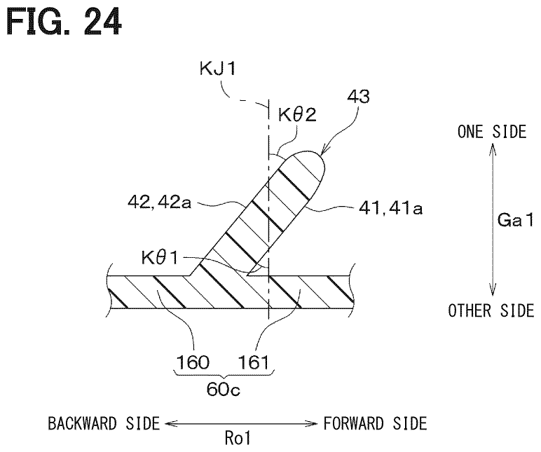

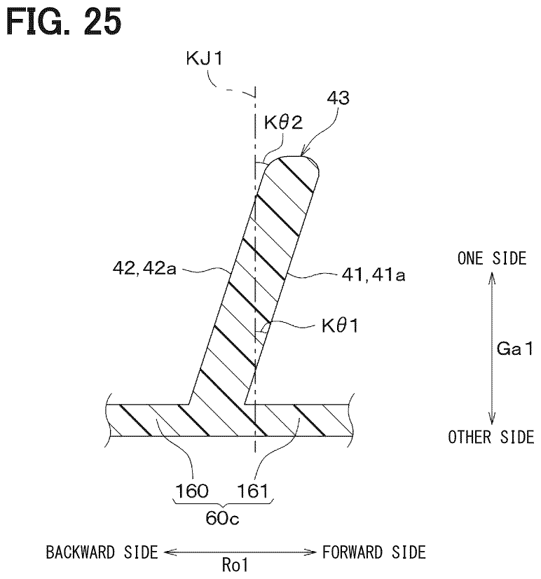

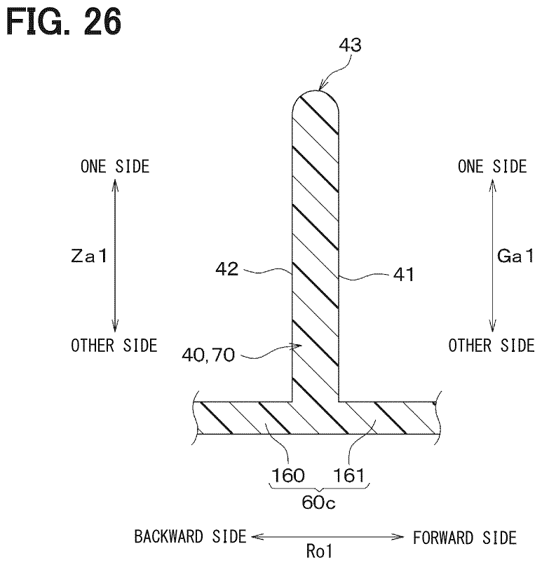

FIG. 22 is an enlarged view of a part of the centrifugal fan 20, showing the blade 40 alone and a part of the shroud ring 50 as viewed from the one side in the axial direction Ga1. FIG. 23 is a cross-sectional view of the centrifugal fan 20, taken along a virtual plane including the axis Za. FIG. 24 is a cross-sectional view taken along line XXIV-XXIV of the leading edge portion 70 of the blade 40 in FIG. 23, and FIG. 25 is a cross-sectional view taken along line XXV-XXV of the leading edge portion 70 of the blade 40 in FIG. 23. FIG. 26 is a cross-sectional view taken along line XXVI-XXVI of the leading edge portion 70 of the blade 40 in FIG. 23.

The centrifugal fan 20 of the present embodiment differs from the centrifugal fan 20 of the first embodiment with respect to the leading edge portion 70 of each of the blades 40. Accordingly, descriptions will be mainly given below regarding the leading edge portion 70 of each of the blades 40 of the centrifugal fan 20 of the present embodiment.

The leading edge portion 70 of each of the blades 40 of the present embodiment includes a leading-edge inclined portion 73a and a leading-edge non-inclined portion 73b.

The leading-edge inclined portion 73a is an inclined region in which, in the cross-sectional views of FIGS. 24 and 25, the positive pressure surface 41 is formed by the line 41a that intersects the reference line KJ1, similarly to the positive pressure surface 41 of the leading edge portion 70 in the first embodiment.

In the cross-sectional views of FIGS. 24 and 25, an acute angle, which is formed between the line 41a and the reference line KJ1, is defined as an inclination angle Kθ1.

In the present embodiment, the positive pressure surface 41 of the leading-edge inclined portion 73a has the inclination angle Kθ1 that decreases as the positive pressure surface 41 extends from the inner side toward the outer side in the radial direction Ka1. The inclination angle Kθ1 in FIG. 24 is larger than the inclination angle Kθ1 in FIG. 25. The reference line KJ1 is a virtual line that intersects the line 41a and extends in the axial direction Ga1.

In the cross-sectional views of FIGS. 24 and 25, the negative pressure surface 42 of the leading-edge inclined portion 73a is formed by the line 42a that intersects the reference line KJ1, similarly to the negative pressure surface 42 of the leading edge portion 70 in the first embodiment. In the cross-sectional views of FIGS. 24 and 25, an acute angle, which is formed between the line 42a and the reference line KJ1, is defined as an inclination angle Kθ2.

In the present embodiment, the negative pressure surface 42 of the leading-edge inclined portion 73a has the inclination angle Kθ2 that decreases as the negative pressure surface 42 extends from the inner side toward the outer side in the radial direction Ka1. The inclination angle Kθ2 in FIG. 24 is larger than the inclination angle Kθ2 in FIG. 25. The reference line KJ1 is a virtual line (i.e., an inclination reference line) that intersects the line 42a and is parallel to the axial direction Ga1.

The leading-edge non-inclined portion 73b is disposed on the side of the leading-edge inclined portion 73a where the shroud ring 50 is disposed. That is, the leading-edge non-inclined portion 73b is disposed on the outer side of the leading-edge inclined portion 73a in the radial direction Ka1.

In the leading-edge non-inclined portion 73b, the positive pressure surface 41 and the negative pressure surface 42 are non-inclined regions each of which is parallel to the axis Za. Furthermore, the leading-edge non-inclined portion 73b is joined to the leading-edge inclined portion 73a.

In the present embodiment described above, the negative pressure surface 42 of the leading edge portion 70 of the blade 40 has the inclination angle Kθ2 that decreases as the negative pressure surface 42 extends from the inner side toward the outer side in the radial direction Ka1. Therefore, the inclination of the negative pressure surface 42 of the blade 40 can be matched to the airflow flowing through the air flow passage 400. Thus, it is possible to reduce the pressure loss generated when the air flows through the air flow passage 400.

### Seventh Embodiment

In the first embodiment, there is described the example, in which, in the cross-sectional view of the blade 40 in FIG. 5, the negative pressure surface 42 of the leading edge portion 70 is formed by the straight line 42a.

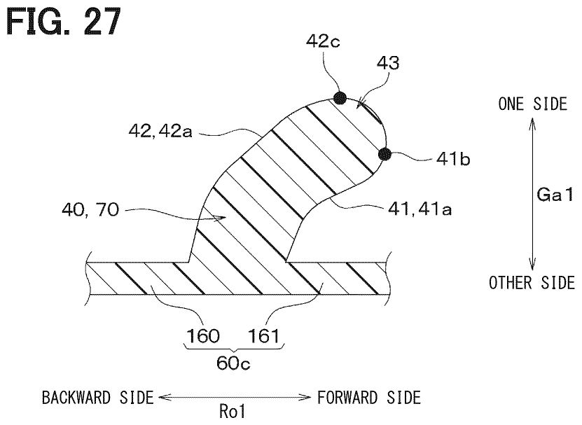

However, in the seventh embodiment, in the cross-sectional view of the blade 40 in FIG. 27, the negative pressure surface 42 of the leading edge portion 70 is formed by a line 42a that is a combination of a plurality of curved lines. Furthermore, in the cross-sectional view of the blade 40 in FIG. 27, the positive pressure surface 41 of the leading edge portion 70 is formed by a line 41a that is a combination of a plurality of curved lines.

FIG. 27 is a cross-sectional view of the leading edge portion 70 of the blade 40, taken along a virtual plane that is perpendicular to the radial direction Ka1, and corresponds to the cross-sectional view in FIG. 5 in the first embodiment.

### Eighth Embodiment

In the second embodiment, there is described the example, in which, in the cross-sectional view of the leading edge portion 70 of the blade 40 in FIG. 18, the positive pressure surface 41 is formed by the lines 41a, 41c.

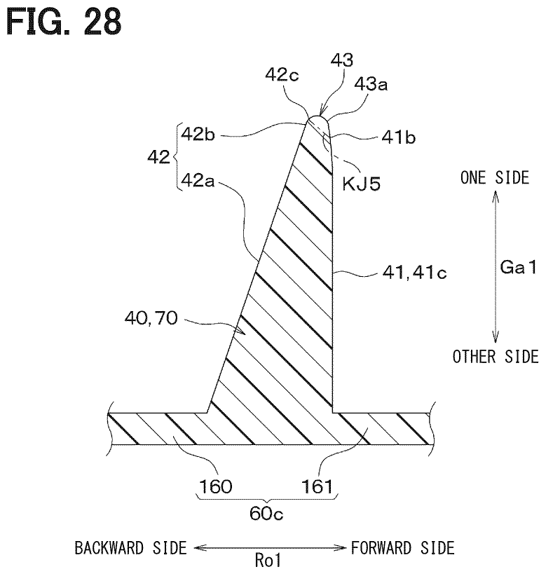

However, instead, there will be described an example, in which, in the cross-sectional view of FIG. 28, the positive pressure surface 41 is defined only by the line 41c.

FIG. 28 is a cross-sectional view of the leading edge portion 70 of the blade 40, taken along a virtual plane that is perpendicular to the radial direction Ka1, and corresponds to the cross-sectional view in FIG. 18 in the second embodiment. In FIG. 28, the same reference signs as those used in FIG. 18 denote the same components, and a detailed description thereof is omitted.

The line 41c of the present embodiment is formed to be parallel to the axis Za. In the cross-sectional view of the leading edge portion 70 of the blade 40 in FIG. 28 of the present embodiment, the negative pressure surface 42 is formed by the lines 42a, 42b, similarly to the first embodiment.

In the present embodiment, a part of the line 41c, which is positioned farthest toward the one side in the axial direction Ga1, is defined as an end part (positive pressure surface end part) 41b. A part of the line 42b, which is positioned farthest toward the one side in the axial direction Ga1, is defined as an end part (negative pressure surface end part) 42c. In the cross-sectional view of FIG. 28, the arcuate convex portion 43 has the outer contour line 43a that bulges from the reference line (i.e., the virtual line) KJ5 that connects between the positive pressure surface end part 41b and the negative pressure surface end part 42c and is formed in the arcuate shape.

According to the present embodiment described above, similarly to the first embodiment described above, it is possible to provide the method for manufacturing the centrifugal fan 20 and the centrifugal fan 20 which enable the integral molding.

### Ninth Embodiment

In the first embodiment, there is described the example, in which the arcuate convex portion 43 is formed at the distal end part of the leading edge portion 70 of the blade 40.

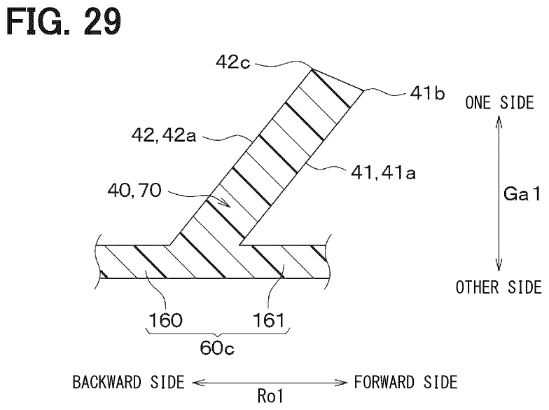

However, in the ninth embodiment, instead, as shown in FIG. 29, the arcuate convex portion 43 may be eliminated from the leading edge portion 70 of the blade 40.

FIG. 29 is a cross-sectional view of the leading edge portion 70 of the blade 40, taken along a virtual plane that is perpendicular to the radial direction Ka1, and corresponds to the cross-sectional view in FIG. 5 in the first embodiment. In FIG. 29, the same reference signs as those used in FIG. 5 denote the same components, and a detailed description thereof is omitted.

With respect to the cross-sectional view of the leading edge portion 70 of the blade 40 in FIG. 29, there is described the example, in which the positive pressure surface 41 is formed by the line 41a. The negative pressure surface 42 is formed by the line 42a. The distal end part of the leading edge portion 70 is formed in a rectangular shape in the cross-sectional view of FIG. 29.

### Other Embodiments

(1) In the first to ninth embodiments, there is described the example, in which the blower device 1 is applied to the vehicle air conditioning apparatus. However, instead, the blower device 1 may be applied to various devices other than vehicle air conditioning apparatuses.

(2) In the first to ninth embodiments, there is described the example, in which the centrifugal fan 20 is formed as the turbo fan. However, instead, the centrifugal fan 20 may be formed as any of various other fans such as a sirocco fan other than the turbo fan.

(3) In the first to ninth embodiments, there is described the example, in which the centrifugal fan 20 is made of the resin material. However, instead, the centrifugal fan 20 may be made of a material other than the resin material, for example, a metal material.

(4) In the first to ninth embodiments, there is described the example, in which the axial core die 130 molds: the side of the main plate inner region 60b, which faces the one side in the axial direction Ga1; the side of each of the intermediate inner regions 160, which faces the one side in the axial direction Ga1; and the arcuate convex portion 43 of each of the blades 40.

However, instead, the side of the main plate inner region 60b, which faces the one side in the axial direction Ga1, the side of each of the intermediate inner regions 160, which faces the one side in the axial direction Ga1, and the arcuate convex portion 43 of each of the blades 40 may be independently molded by independent dies, respectively.

(5) In the first to ninth embodiments, there is described the example, in which each of the lower slide dies 110 and the corresponding one of the upper slide dies 120 are provided to mold the positive pressure surface 41 of the corresponding rear blade 40b and the negative pressure surface 42 of the corresponding front blade 40a.

However, instead, a die, in which the lower slide die 110 and the upper slide die 120 are integrated, may be used to mold the positive pressure surface 41 of each of the leading edge portion 70 and the trailing edge portion 71 of the corresponding rear blade 40b and the negative pressure surface 42 of the leading edge portion 70 of the corresponding front blade 40a.

(6) The present disclosure is not limited to the above embodiments, and the above embodiments may be appropriately modified. Further, the above embodiments are not unrelated to each other and can be appropriately combined unless the combination is clearly impossible. Needless to say, in each of the above-described embodiments, the elements of the embodiment are not necessarily essential except when it is clearly indicated that they are essential and when they are clearly considered to be essential in principle. In each of the embodiments described above, when a numerical value such as the number, numerical value, amount, range or the like of the constituent elements of the embodiment is mentioned, the present disclosure should not be limited to such a numerical value unless it is clearly stated that it is essential and/or it is required in principle. In each of the embodiments described above, when the shape, the positional relationship or the like of the constituent elements of the embodiment are mentioned, the present disclosure should not be limited to the shape, the positional relationship or the like unless it is clearly stated that it is essential and/or it is required in principle.

### Various Aspects

### Aspect 1

According to aspect 1, there is provided a method for manufacturing a centrifugal fan, the centrifugal fan including:
a plurality of blades that are arranged at intervals in a circumferential direction about an axis;
a ring that is formed in a ring shape and is centered on the axis, wherein a direction, in which the axis extends, is defined as an axial direction, and the ring is joined to the plurality of blades on one side in the axial direction; and
a main plate that has a thickness in the axial direction, wherein the main plate is joined to the plurality of blades on another side in the axial direction, wherein:
when the plurality of blades, the ring and the main plate are rotated together toward a forward side in a rotational direction about the axis, air, which is drawn from the one side in the axial direction, is blown toward an outer side in a radial direction about the axis;
each of the plurality of blades includes:
   a leading edge portion that is disposed on an inner side of the ring in the radial direction about the axis; and
   a trailing edge portion that is disposed on the outer side of the leading edge portion in the radial direction;
each of the plurality of blades further includes:
   a positive pressure surface that faces the forward side in the rotational direction; and
   a negative pressure surface that faces a backward side in the rotational direction;
in a cross-section of the leading edge portion of each of the plurality of blades taken along a virtual plane perpendicular to the radial direction, the negative pressure surface is formed by at least one line which extends toward the forward side in the rotational direction as the at least one line extends toward the one side in the axial direction;
in the cross-section of the leading edge portion of each of the plurality of blades, the positive pressure surface is formed by at least one of:
   a line that extends toward the forward side in the rotational direction as the line extends toward the one side in the axial direction; and
   a line that extends in parallel with the axis;
an end part of the positive pressure surface of the leading edge portion, which is positioned furthest toward the one side in the axial direction, is defined as a positive pressure surface end part;
an end part of the negative pressure surface of the leading edge portion, which is positioned furthest toward the one side in the axial direction, is defined as a negative pressure surface end part, wherein the leading edge portion includes a convex portion that bulges from a virtual line that connects between the positive pressure surface end part and the negative pressure surface end part; and
a virtual line, which passes through the positive pressure surface end part and extends in the axial direction in the cross-section of the leading edge portion, is defined as a first reference line, and a virtual line, which passes through the negative pressure surface end part and extends in the rotational direction in the cross-section of the leading edge portion, is defined as a second reference line, and the convex portion is disposed on the backward side of the first reference line in the rotational direction and on the another side of the second reference line in the axial direction, the method including:
assembling a first die, a second die, a plurality of third dies and a fourth die together, wherein:
the first die is configured to mold a side of the main plate which faces the another side in the axial direction;
the second die is configured to mold:
   a side of a main plate inner region of the main plate, which faces the one side in the axial direction, wherein the main plate inner region is disposed on the inner side of the plurality of blades in the radial direction;
   the convex portion of each of the plurality of blades;
   the negative pressure surface of the leading edge portion of each of the plurality of blades; and
   a side of each of a plurality of first regions of the main plate which faces the one side in the axial direction, wherein each of the plurality of first regions is disposed on the outer side of the main plate inner region in the radial direction and is joined to the negative pressure surface of the leading edge portion of an adjacent one of the plurality of blades that is adjacent to the first region;
each of the plurality of third dies is configured to mold:
   the positive pressure surface of each of the trailing edge portion and the leading edge portion of one of adjacent two of the plurality of blades that are disposed adjacent to the third die;
   the negative pressure surface of the trailing edge portion of another one of the adjacent two of the plurality of blades;
   a side of a second region of the main plate which is disposed adjacent to the third die and faces the one side in the axial direction, wherein the second region is disposed between the adjacent two of the plurality of blades and is disposed on the outer side of a corresponding one of the plurality of first regions in the radial direction, and the corresponding one of the plurality of first regions is disposed between the adjacent two of the plurality of blades; and
   a side of an adjacent portion of the ring which is adjacent to the third die and faces the another side in the axial direction; and
the fourth die is configured to mold a side of the ring which faces the one side in the axial direction;
injecting a material, which has flowability, into a molding region that is formed by the first die, the second die, the plurality of third dies and the fourth die;
molding an integrated article, which includes the plurality of blades, the ring and the main plate integrated together, in the molding region, by solidifying the material injected into the molding region; and
separating the first die, the second die, the plurality of third dies and the fourth die from the integrated article.

### Aspect 2

According to aspect 2, there is provided the method for manufacturing the centrifugal fan according to aspect 1, wherein each of the plurality of third dies includes:
a lower slide die that is configured to mold:
   the positive pressure surface of each of the trailing edge portion and the leading edge portion of the one of the adjacent two of the plurality of blades;
   the negative pressure surface of the trailing edge portion of the another one of the adjacent two of the plurality of blades; and
   the side of the second region which faces the one side in the axial direction; and
an upper slide die that is disposed on the one side of the lower slide die in the axial direction and is configured to mold:
   the positive pressure surface of each of the trailing edge portion and the leading edge portion of the one of the adjacent two of the plurality of blades;
   the negative pressure surface of the trailing edge portion of the another one of the adjacent two of the plurality of blades; and
   the side of the adjacent portion of the ring, which faces the another side in the axial direction.

### Aspect 3

According to aspect 3, there is provided a centrifugal fan including:
a plurality of blades that are arranged at intervals in a circumferential direction about an axis;
a ring that is formed in a ring shape and is centered on the axis, wherein a direction, in which the axis extends, is defined as an axial direction, and the ring is joined to the plurality of blades on one side in the axial direction; and
a main plate that has a thickness in the axial direction, wherein the main plate is joined to the plurality of blades on another side in the axial direction, wherein:
when the plurality of blades, the ring and the main plate are rotated together toward a forward side in a rotational direction about the axis, air, which is drawn from the one side in the axial direction, is blown toward an outer side in a radial direction about the axis;
each of the plurality of blades includes a leading edge portion that is disposed on an inner side of the ring in the radial direction about the axis;
each of the plurality of blades further includes:
   a positive pressure surface that faces the forward side in the rotational direction; and
   a negative pressure surface that faces a backward side in the rotational direction;
in a cross-section of the leading edge portion of each of the plurality of blades taken along a virtual plane perpendicular to the radial direction, the negative pressure surface is formed by at least one line which extends toward the forward side in the rotational direction as the at least one line extends toward the one side in the axial direction;
in the cross-section of the leading edge portion of each of the plurality of blades, the positive pressure surface is formed by at least one of:
   a line that extends toward the forward side in the rotational direction as the line extends toward the one side in the axial direction; and
   a line that extends in parallel with the axis;
an end part of the positive pressure surface of the leading edge portion, which is positioned furthest toward the one side in the axial direction, is defined as a positive pressure surface end part;
an end part of the negative pressure surface of the leading edge portion, which is positioned furthest toward the one side in the axial direction, is defined as a negative pressure surface end part, wherein the leading edge portion includes a convex portion that bulges from a virtual line that connects between the positive pressure surface end part and the negative pressure surface end part; and
a virtual line, which passes through the positive pressure surface end part and extends in the axial direction in the cross-section of the leading edge portion, is defined as a first reference line, and a virtual line, which passes through the negative pressure surface end part and extends in the rotational direction in the cross-section of the leading edge portion, is defined as a second reference line, and the convex portion is disposed on the backward side of the first reference line in the rotational direction and on the another side of the second reference line in the axial direction.

### Aspect 4

According to aspect 4, there is provided the centrifugal fan according to aspect 3, wherein the convex portion has an outer contour line that is formed in an arcuate shape in the cross-section of the leading edge portion.

### Aspect 5

According to aspect 5, there is provided the centrifugal fan according to aspect 3 or 4, wherein:
in the cross-section of the leading edge portion, the positive pressure surface is formed by:
   a first line segment that extends toward the forward side in the rotational direction as the first line segment extends toward the one side in the axial direction; and
   a second line segment that is joined to the first line segment, wherein the second line segment extends toward the forward side in the rotational direction as the second line segment extends toward the one side in the axial direction;
a virtual line, which intersects the first line segment and extends in the axial direction, is defined as a third reference line;
an acute angle, which is formed between the first line segment and the third reference line, is defined as a first inclination angle;
a virtual line, which intersects the second line segment and extends in the axial direction, is defined as a fourth reference line;
an acute angle, which is formed between the second line segment and the fourth reference line, is defined as a second inclination angle; and
the first line segment and the second line segment are set such that the first inclination angle and the second inclination angle are different from each other.

### Aspect 6

According to aspect 6, there is provided the centrifugal fan according to aspect 3 or 4, wherein:
in the cross-section of the leading edge portion, a virtual line, which intersects the negative pressure surface and is parallel to the axis, is defined as an inclination reference line, and an acute angle, which is formed between the negative pressure surface and the inclination reference line, is defined as an inclination angle; and
the leading edge portion is formed such that the inclination angle decreases as the leading edge portion approaches the ring.

### Aspect 7

According to aspect 7, there is provided the centrifugal fan according to aspect 6, wherein:
the leading edge portion includes:
   an inclined region in which the inclination angle is larger than zero degrees; and
   a non-inclined region which is disposed on the outer side of the inclined region in the radial direction and in which the inclination angle is zero degrees; and
the inclined region is formed such that the inclination angle decreases as the inclined region approaches the non-inclined region.

What is claimed is:

1. A method for manufacturing a centrifugal fan, the centrifugal fan including:
a plurality of blades that are arranged at intervals in a circumferential direction about an axis;
a ring that is formed in a ring shape and is centered on the axis, wherein a direction, in which the axis extends, is defined as an axial direction, and the ring is joined to the plurality of blades on one side in the axial direction; and
a main plate that has a thickness in the axial direction, wherein the main plate is joined to the plurality of blades on another side in the axial direction, wherein:
when the plurality of blades, the ring and the main plate are rotated together toward a forward side in a rotational direction about the axis, air, which is drawn from the one side in the axial direction, is blown toward an outer side in a radial direction about the axis;
each of the plurality of blades includes:
a leading edge portion that is disposed on an inner side of the ring in the radial direction about the axis; and
a trailing edge portion that is disposed on the outer side of the leading edge portion in the radial direction;
each of the plurality of blades further includes:
a positive pressure surface that faces the forward side in the rotational direction; and
a negative pressure surface that faces a backward side in the rotational direction;
in a cross-section of the leading edge portion of each of the plurality of blades taken along a virtual plane perpendicular to the radial direction, the negative pressure surface is formed by at least one line which extends toward the forward side in the rotational direction as the at least one line extends toward the one side in the axial direction;
in the cross-section of the leading edge portion of each of the plurality of blades, the positive pressure surface is formed by at least one of:
a line that extends toward the forward side in the rotational direction as the line extends toward the one side in the axial direction; and
a line that extends in parallel with the axis;
an end part of the positive pressure surface of the leading edge portion, which is positioned furthest toward the one side in the axial direction, is defined as a positive pressure surface end part;
an end part of the negative pressure surface of the leading edge portion, which is positioned furthest toward the one side in the axial direction, is defined as a negative pressure surface end part, wherein the leading edge portion includes a convex portion that bulges from a virtual line that connects between the positive pressure surface end part and the negative pressure surface end part; and
a virtual line, which passes through the positive pressure surface end part and extends in the axial direction in the cross-section of the leading edge portion, is defined as a first reference line, and a virtual line, which passes through the negative pressure surface end part and extends in the rotational direction in the cross-section of the leading edge portion, is defined as a second reference line, and the convex portion is disposed on the backward side of the first reference line in the rotational direction and on the another side of the second reference line in the axial direction, the method comprising:
assembling a first die, a second die, a plurality of third dies and a fourth die together, wherein:
the first die is configured to mold a side of the main plate which faces the another side in the axial direction;
the second die is configured to mold:
a side of a main plate inner region of the main plate, which faces the one side in the axial direction, wherein the main plate inner region is disposed on the inner side of the plurality of blades in the radial direction;
the convex portion of each of the plurality of blades;
the negative pressure surface of the leading edge portion of each of the plurality of blades; and
a side of each of a plurality of first regions of the main plate which faces the one side in the axial direction, wherein each of the plurality of first regions is disposed on the outer side of the main plate inner region in the radial direction and is joined to the negative pressure surface of the leading edge portion of an adjacent one of the plurality of blades that is adjacent to the first region;
each of the plurality of third dies is configured to mold:
the positive pressure surface of each of the trailing edge portion and the leading edge portion of one of adjacent two of the plurality of blades that are disposed adjacent to the third die;
the negative pressure surface of the trailing edge portion of another one of the adjacent two of the plurality of blades;
a side of a second region of the main plate which is disposed adjacent to the third die and faces the one side in the axial direction, wherein the second region is disposed between the adjacent two of the plurality of blades and is disposed on the outer side of a corresponding one of the plurality of first regions in the radial direction, and the corresponding one of the plurality of first regions is disposed between the adjacent two of the plurality of blades; and
a side of an adjacent portion of the ring which is adjacent to the third die and faces the another side in the axial direction; and
the fourth die is configured to mold a side of the ring which faces the one side in the axial direction;
injecting a material, which has flowability, into a molding region that is formed by the first die, the second die, the plurality of third dies and the fourth die;
molding an integrated article, which includes the plurality of blades, the ring and the main plate integrated together, in the molding region, by solidifying the material injected into the molding region; and
separating the first die, the second die, the plurality of third dies and the fourth die from the integrated article.

2. The method for manufacturing the centrifugal fan according to claim 1, wherein each of the plurality of third dies includes:
a lower slide die that is configured to mold:
the positive pressure surface of each of the trailing edge portion and the leading edge portion of the one of the adjacent two of the plurality of blades;
the negative pressure surface of the trailing edge portion of the another one of the adjacent two of the plurality of blades; and
the side of the second region which faces the one side in the axial direction; and
an upper slide die that is disposed on the one side of the lower slide die in the axial direction and is configured to mold:
the positive pressure surface of each of the trailing edge portion and the leading edge portion of the one of the adjacent two of the plurality of blades;
the negative pressure surface of the trailing edge portion of the another one of the adjacent two of the plurality of blades; and
the side of the adjacent portion of the ring, which faces the another side in the axial direction.

3. A centrifugal fan comprising:
a plurality of blades that are arranged at intervals in a circumferential direction about an axis;
a ring that is formed in a ring shape and is centered on the axis, wherein a direction, in which the axis extends, is defined as an axial direction, and the ring is joined to the plurality of blades on one side in the axial direction; and
a main plate that has a thickness in the axial direction, wherein the main plate is joined to the plurality of blades on another side in the axial direction, wherein:
when the plurality of blades, the ring and the main plate are rotated together toward a forward side in a rotational direction about the axis, air, which is drawn from the one side in the axial direction, is blown toward an outer side in a radial direction about the axis;
each of the plurality of blades includes a leading edge portion that is disposed on an inner side of the ring in the radial direction about the axis;
each of the plurality of blades further includes:
a positive pressure surface that faces the forward side in the rotational direction; and
a negative pressure surface that faces a backward side in the rotational direction;
in a cross-section of the leading edge portion of each of the plurality of blades taken along a virtual plane perpendicular to the radial direction, the negative pressure surface is formed by at least one line which extends toward the forward side in the rotational direction as the at least one line extends toward the one side in the axial direction;
in the cross-section of the leading edge portion of each of the plurality of blades, the positive pressure surface is formed by at least one of:
a line that extends toward the forward side in the rotational direction as the line extends toward the one side in the axial direction; and
a line that extends in parallel with the axis;
an end part of the positive pressure surface of the leading edge portion, which is positioned furthest toward the one side in the axial direction, is defined as a positive pressure surface end part;
an end part of the negative pressure surface of the leading edge portion, which is positioned furthest toward the one side in the axial direction, is defined as a negative pressure surface end part, wherein the leading edge portion includes a convex portion that bulges from a virtual line that connects between the positive pressure surface end part and the negative pressure surface end part; and
a virtual line, which passes through the positive pressure surface end part and extends in the axial direction in the cross-section of the leading edge portion, is defined as a first reference line, and a virtual line, which passes through the negative pressure surface end part and extends in the rotational direction in the cross-section of the leading edge portion, is defined as a second reference line, and the convex portion is disposed on the backward side of the first reference line in the rotational direction and on the another side of the second reference line in the axial direction.

4. The centrifugal fan according to claim 3, wherein the convex portion has an outer contour line that is formed in an arcuate shape in the cross-section of the leading edge portion.

5. The centrifugal fan according to claim 3, wherein:
in the cross-section of the leading edge portion, the positive pressure surface is formed by:
a first line segment that extends toward the forward side in the rotational direction as the first line segment extends toward the one side in the axial direction; and
a second line segment that is joined to the first line segment, wherein the second line segment extends toward the forward side in the rotational direction as the second line segment extends toward the one side in the axial direction;
a virtual line, which intersects the first line segment and extends in the axial direction, is defined as a third reference line;
an acute angle, which is formed between the first line segment and the third reference line, is defined as a first inclination angle;
a virtual line, which intersects the second line segment and extends in the axial direction, is defined as a fourth reference line;
an acute angle, which is formed between the second line segment and the fourth reference line, is defined as a second inclination angle; and
the first line segment and the second line segment are set such that the first inclination angle and the second inclination angle are different from each other.

6. The centrifugal fan according to claim 3, wherein:
in the cross-section of the leading edge portion, a virtual line, which intersects the negative pressure surface and is parallel to the axis, is defined as an inclination reference line, and an acute angle, which is formed between the negative pressure surface and the inclination reference line, is defined as an inclination angle; and
the leading edge portion is formed such that the inclination angle decreases as the leading edge portion approaches the ring.

7. The centrifugal fan according to claim 6, wherein:
the leading edge portion includes:
an inclined region in which the inclination angle is larger than zero degrees; and
a non-inclined region which is disposed on the outer side of the inclined region in the radial direction and in which the inclination angle is zero degrees; and
the inclined region is formed such that the inclination angle decreases as the inclined region approaches the non-inclined region.
